(19) United States
(12) Patent Application Publication
(10) Pub. No.: US 2024/0257162 A1
(43) Pub. Date: Aug. 1, 2024

(54) METHODS, SYSTEMS, ARTICLES OF MANUFACTURE, AND APPARATUS TO ADJUST MARKET STRATEGIES

(71) Applicant: Nielsen Consumer LLC, Chicago, IL (US)

(72) Inventors: Morgan Seybert, Chicago, IL (US); Emma Fiore, Chicago, IL (US); Troy Treangen, Chicago, IL (US)

(21) Appl. No.: 18/585,883

(22) Filed: Feb. 23, 2024

Related U.S. Application Data
(63) Continuation of application No. 17/243,254, filed on Apr. 28, 2021, now abandoned.
(60) Provisional application No. 63/068,743, filed on Aug. 21, 2020.

(51) Int. Cl. G06Q 30/0201; G06N 20/00; G06Q 30/0211; G06Q 30/0235

(52) U.S. Cl. CPC G06Q 30/0201; G06N 20/00; G06Q 30/0206; G06Q 30/0211; G06Q 30/0235

(57) ABSTRACT

Methods, apparatus, systems and articles of manufacture are disclosed to control market strategy adjustments. An example apparatus includes a target principle generator to determine a target principle of a product based on at least one lever, the at least one lever indicative of an adjustable parameter corresponding to the product, an execution analyzer to compare in-market data of the product to the target principle of the product, a score generator to determine an aggregate score of the product based on the comparison, and an output generator to reduce discretionary input of an analyst by generating an output, the output including the aggregate score of the product and a recommended adjustment to the at least one lever.

### RELATED APPLICATION

This patent claims the benefit of U.S. Provisional Patent Application Ser. No. 63/068,743, which was filed on Aug. 21, 2020. U.S. Provisional Patent Application Ser. No. 63/068,743 is hereby incorporated herein by reference in its entirety. Priority to U.S. Provisional Patent Application Ser. No. 63/068,743 is hereby claimed.

### FIELD OF THE DISCLOSURE

This disclosure relates generally to the technical field of market research, and, more particularly, to methods, systems, articles of manufacture, and apparatus to identify market strategies.

### BACKGROUND

In recent years, retailers and manufacturers have been combining data, analytics, and role-based applications to identify actionable insights. Retailers and manufacturers mine through billions of datapoints to generate hundreds of business intelligence (BI) reports.

### BRIEF DESCRIPTION OF THE DRAWINGS

FIG. 1 illustrates an example market strategy identification system constructed in accordance with the teachings of this disclosure to analyze market data.

FIG. 2 is a block diagram of an example action determiner of FIG. 1 to identify an action for a marketing strategy.

FIG. 3 illustrates an example market strategy identification architecture.

FIG. 4 illustrates example point of sale data used by the example system of FIG. 1 to identify an action for a marketing strategy.

FIG. 5 illustrates an example score aggregation architecture.

FIGS. 6-8 illustrate an example market strategy workflow for market analysts.

FIGS. 9A-9B illustrate an example alert generated by the example system of FIG. 1.

FIGS. 10-12 illustrate example user interfaces to display a market strategy report.

FIG. 13 illustrates example net profit data used by the example system of FIG. 1 to identify an action for a marketing strategy.

FIG. 14 illustrates an example decision framework.

FIG. 15 is a flowchart representative of an example method that may be executed by the example action determiner of FIGS. 1 and/or 2 to identify an action for a marketing strategy.

FIG. 16 is a flowchart representative of an example method that may be executed by the example pricing determiner of FIG. 2 to determine a target principle for the price lever.

FIG. 17 is a flowchart representative of an example method that may be executed by the example promotion determiner of FIG. 2 to determine a target principle for the promotion lever.

FIG. 18 is a flowchart representative of an example method that may be executed by the example assortment determiner of FIG. 2 to determine a target principle for the assortment lever.

FIG. 19 is a flowchart representative of an example method that may be executed by the example new product determiner of FIG. 2 to determine a target principle for the new product lever.

FIG. 20 is a flowchart representative of an example method that may be executed by the example in-store execution determiner of FIG. 2 to determine a target principle for the execution lever.

FIG. 21 is a block diagram of an example processing platform structured to execute machine readable instructions to implement the method of FIGS. 15-20 and/or the example action determiner of FIGS. 1 and/or 2.

FIG. 22 is a block diagram of an example software distribution platform to distribute software (e.g., software corresponding to the example computer readable instructions of FIGS. 15-20) to client devices such as consumers (e.g., for license, sale and/or use), retailers (e.g., for sale, re-sale, license, and/or sub-license), and/or original equipment manufacturers (OEMs) (e.g., for inclusion in products to be distributed to, for example, retailers and/or to direct buy customers.

The figures are not to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular. In general, the same reference numbers will be used throughout the drawing(s) and accompanying written description to refer to the same or like parts. As noted above, a first part can be above or below a second part with one or more of: other parts therebetween, without other parts therebetween, with the first and second parts touching, or without the first and second parts being in direct contact with one another.

Unless specifically stated otherwise, descriptors such as “first,” “second,” “third,” etc. are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time+/−1 second.

### DETAILED DESCRIPTION

In recent years, the need for data and analytics has risen in the retail and/or manufacturing realm due to fast-paced markets and increased competition. Market data and analytics can deliver actionable insights for a company and provide better knowledge as to how that company pairs up against competitors and similar markets based on real-time market data.

The real-time market data can include anything from measuring sales performances of retail companies to optimizing in-store execution such as price, promotion and assortment. From there, client analysis is performed, and insights are generated specifically for clients to adjust levers. As used herein, a “lever” represents categories a client can adjust regarding the marketing of a product (e.g., item). That is, a lever is indicative of an adjustable parameter of the product. Levers can include product price, product promotion budgets, product assortments, new products, and/or product in-store execution such as display support. For example, clients can adjust levers to increase the impact of their promotion budgets, optimize their product assortments, optimize the number and type of new products introduced, and/or optimize in-store placement strategy. In some examples, clients adjust levers based on sub-levers. As used herein, a “sub-lever” represents a sub-category of a lever. For example, the price lever can include a price gap to competition sub-lever, a price threshold sub-lever, and/or a price strategy sub-lever. These insights may also provide sales predictions based on the changes in a client's offerings, pricings, and/or marketing.

Existing technologies, systems and/or methods of analyzing market data includes mining through billions of data points to find and/or otherwise calculate key insights that help retailers and manufacturers optimize their in-market strategies. Accordingly, the technical field of market research is entrenched in technological tools to perform any number of analysis efforts that would make such efforts impractical for market analysts to perform on a manual basis. For example, current market analysis methods generate hundreds of business intelligence (BI) reports and/or tools for a market analyst to manually review to develop a cohesive plan of action. A market analyst utilizes computational tools in an effort to apply one or more traditional BI tools relevant to an analysis effort. Despite recent improvements in computing system processing capabilities, such traditional BI tools will likely miss and/or otherwise fail to reveal hidden insights that are hidden in the BI reports. The time taken by a market analyst using relevant BI tools is often significant and can render the insights useless due to lack of timely delivery.

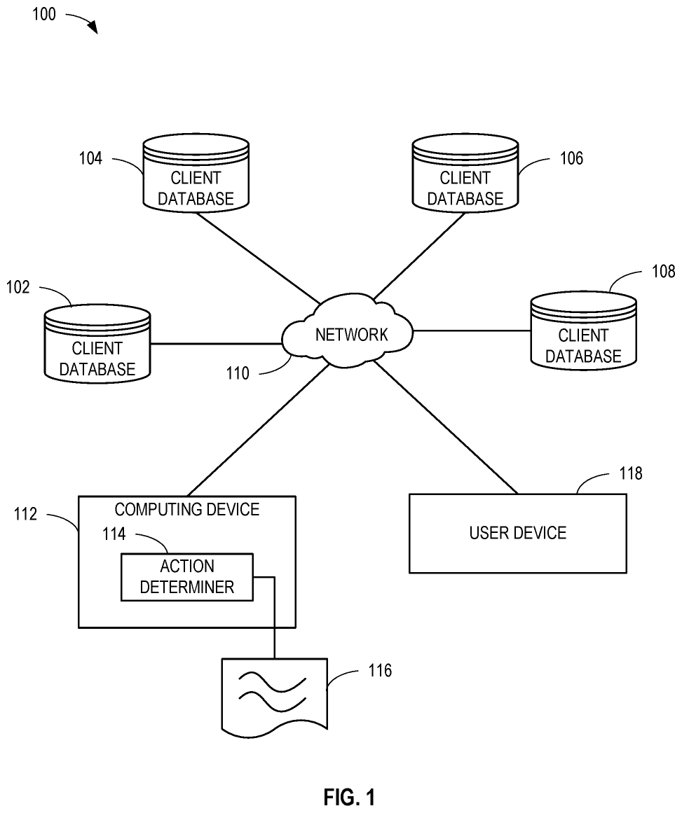

In the illustrated example of FIG. 1, a market strategy identification system 100 includes any number of example client databases 102, 104, 106, 108, an example network 110, an example computing device 112, an example action determiner 114, and an example user device 118.

In the illustrated example of FIG. 1, the respective client databases 102, 104, 106, 108 contain product information for associated individual clients (e.g., different retail chains, different brands, etc.). That is, the client databases 102, 104, 106, 108 store point of sale (POS) data. In examples disclosed herein, the client database 102 stores market data such as universal product code (UPC) level data including volumetric sales, price data, promotion data, and/or audit data. The client database 102 can store retail chain data (e.g., data from Target®, Walmart®, etc.) and/or independent retail data. For example, the client database 102 can cover grocery data, drug data, military commissary data, liquor data, etc.

In the illustrated example of FIG. 1, the client database 104 stores panelist data. For example, the client database 104 can store longitudinal shopper behavior data of one or more households. As used herein, “longitudinal shopper behavior data” refers to panelist data collected over a period of time. That is, the data stored in the client database 104 provides context on the shopper behavior data stored in the client database 102 driving the volumetric performance. For example, the data stored in the client database 104 can be used to determine market penetration and trip frequency. In some examples, the client database 104 includes data not stored and/or associated with the data stored in the client database 102. For example, the client database 104 stores data from retailers not included in the client database 102 (e.g., Costco®, Dollar Tree®, etc.).

In the illustrated example of FIG. 1, the client database 106 stores location data. For example, the client database 106 stores geographic and demographic approximation data associated with the POS data stored in the client database 102 and/or the client database 104.

In the illustrated example of FIG. 1, the client database 108 stores integration data. That is, the data stored in the client database 108 can be used to integrate data stored in the client database 102 and data stored in the client database 106. Additionally or alternatively, the client database 108 stores metadata of one or more retailers to create classes of trade, etc.

In the illustrated example of FIG. 1, the network 110 facilitates communication between the client databases 102, 104, 106, 108 and/or the computing device 112. In some examples, any number of client databases 102, 104, 106, 108 can be communicatively coupled to the computing device 112 via the network 110. The communication provided by the network 110 can be via, for example, the Internet, an Ethernet connection, USB cable, etc.

In the illustrated example of FIG. 1, the computing device 112 communicates with the client databases 102, 104,106, 108 through the network 110. The computing device 112 includes an action determiner 114. In the illustrated example of FIG. 1, the computing device 112 is a server, but alternatively may be an Internet gateway, a laptop, a cellular phone, a tablet, etc.

In the illustrated example of FIG. 1, the action determiner 114 accesses and analyzes the data stored in the client databases 102, 104, 106, 108 to determine a target market strategy for price, promotion, new products, assortment, and/or in-market execution. In examples disclosed herein, the action determiner 114 uses one or more machine learning queries to continuously monitor real-time market data and compare the real-time market data to the target market strategy. The action determiner 114 scores (e.g., ranks, prioritizes, etc.) the accounts and/or products of retailers and/or manufacturers based on compliance to the target market strategy to prioritize focus against the highest leverage opportunities. That is, the action determiner 114 determines and ranks one or more actions to increase sales and/or profit of products. The action determiner 114 generates an example report 116 displaying the accounts, products, and/or levers where an action is recommended and the specific action to take by lever and sub-lever. In some examples, the action determiner 114 causes and/or otherwise invokes the actions that satisfy a threshold rank of candidate actions. For instance, the action determiner 114 causes one or more particular advancements to be displayed in one or more particular geographic markets of interest. In some examples, candidate advancements are stored in geographically located databases, in which the example action determiner 114 releases and/or otherwise authorizes the release of the candidate advancements for display/rendering. In still other examples, the action determiner 114 causes communication and/or otherwise transmits price point settings to one or more retailer systems in response to calculating such price points in a manner to improve sales. In some examples, the action determiner 114 is an application-specific integrated circuit (ASIC), and in some examples the action determiner 114 is a field programmable gate array (FPGA). Alternatively, the action determiner 114 can be software located in the firmware of the computing device 112.

In the illustrated example of FIG. 1, the user device 118 communicates with the computing device 112 through the network 110. For example, the user device 118 obtains the report 116. In some examples, the user device 118 displays the report 116 to a market analyst. That is, a market analyst can interact with the user device 118 to request the report 116, analyze the report 116, etc. In the illustrated example of FIG. 1, the user device 118 is a personal computer, but alternatively may be a laptop, a tablet, a cellular phone, etc.

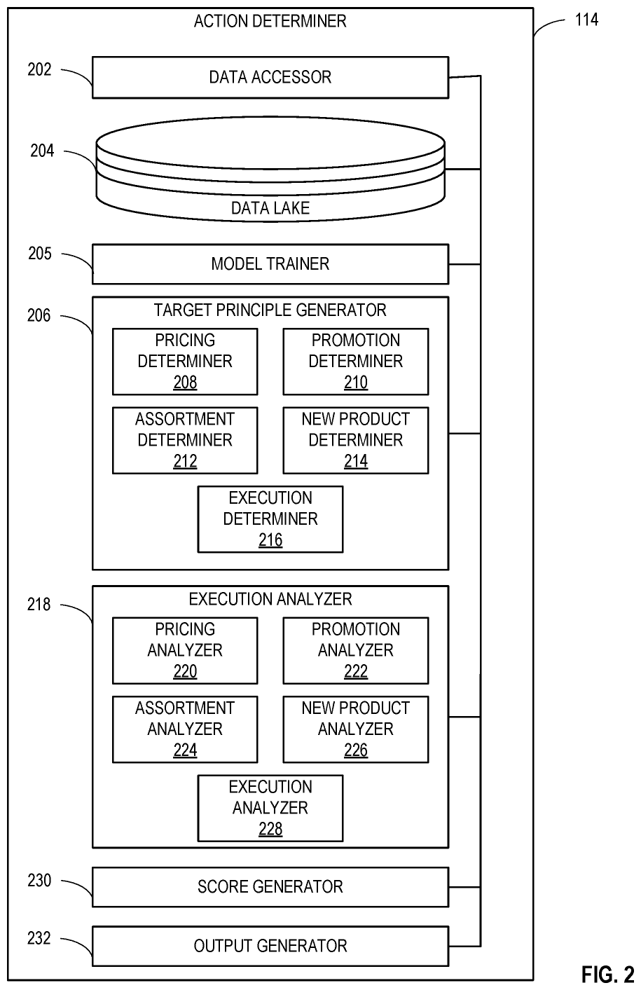

In the illustrated example of FIG. 2, the action determiner 114 includes an example data accessor 202 to access the data stored in the client databases 102, 104, 106, 108. In some examples, the data accessor 202 includes means for accessing data (sometimes referred to herein as data accessing means). The example means for accessing data is hardware. In some examples, the data accessor 202 accesses the client databases 102, 104, 106, 108 content in response to a query, on a manual basis, on a periodic basis, or on a scheduled basis. For example, the data accessor 202 may access the client databases 102, 104, 106, 108 once a month, once a quarter, once a year, etc. to develop one or more marketing strategies. In some examples, the data accessor 202 harmonizes, normalizes and/or otherwise formats the data accessed from the client databases 102, 104, 106, 108. For example, the data accessor 202 deduplicates the data obtained from the client databases 102, 104, 106, 108.

In the illustrated example of FIG. 2, the action determiner 114 includes an example data lake 204. The example data lake 204 stores the data obtained by the data accessor 202. For example, the data lake 204 stores the deduplicated data from the client databases 102, 104, 106, 108. In some examples, the data lake 204 is external to the action determiner 114. For example, the data lake 204 can be implemented in network accessible storage (NAS), etc.

In the illustrated example of FIG. 2, the action determiner 114 includes an example model trainer 205. In some examples, the model trainer 205 includes means for model training (sometimes referred to herein as model training means). The example means for model training is hardware. The example model trainer 205 trains a machine learning model to identify target strategies for one or more market levers (e.g., price, promotion, new products, assortment, and/or in-market execution).

In the illustrated example of FIG. 2, the action determiner 114 includes an example target principle generator 206. In some examples, the target principle generator 206 includes means for determining a target principle (sometimes referred to herein as target principle determining means). The example means for determining a target principle is hardware. The example target principle generator 206 applies the machine learning model to determine target business strategies. For example, the target principle generator 206 determines guidelines (e.g., principles, rules, target metrics, parameter, etc.) for one or more market levers at the market, account, and/or store level. In some examples, the target principles are conditions deemed “optimal” by the target principle generator 206. In the illustrated example of FIG. 2, the target principle generator 206 includes an example pricing determiner 208, an example promotion determiner 210, an example assortment determiner 212, an example new product determiner 214, and an example execution determiner 216 (sometimes referred-to as an in-store execution determiner 216). For example, the target principle generator 206 determines target principles for the pricing lever, the promotion lever, the assortment lever, the new product lever, and/or the execution lever. However, the target principle generator 206 can additionally or alternatively determine target principles for any suitable lever and/or sub-lever at the market, account, and/or store level.

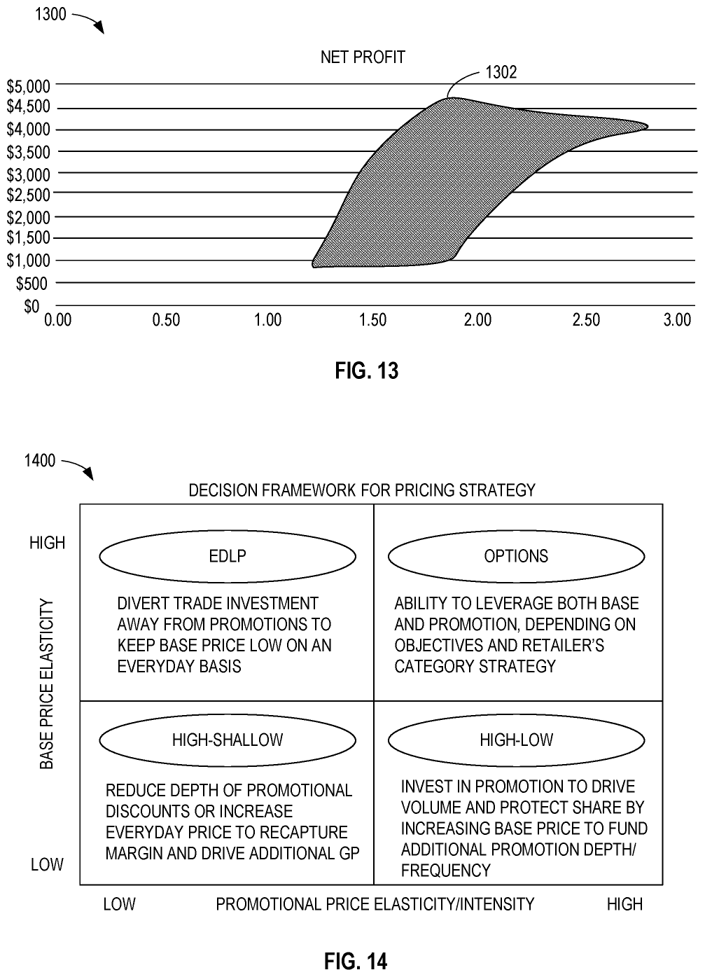

The example pricing determiner 208 determines target pricing principles (e.g., values) to determine the target price of a product. In some examples, the pricing determiner 208 includes means for determining target pricing principles (sometimes referred to herein as target pricing principles determining means). The example means for determining target pricing principles is hardware. For example, the pricing determiner 208 analyzes sub-levers of the price lever (e.g., target price gaps, recommended price strategy, everyday price thresholds, target price positions, target price velocity, target historical price changes, etc.). For example, the example pricing determiner 208 determines a target everyday price for a product to increase (e.g., maximize) profit and volume growth. The example pricing determiner 208 can determine target internal price gaps (e.g., price gap between different sizes of a product within the same brand) and/or target external price gaps (e.g., price gap between different brands of the product). In some examples, the pricing determiner 208 uses a Monte Carlo simulation of different price gap permutations between a pair of internal competitors (e.g., within a brand) and external competitors (e.g., between one or more brands). For example, the pricing determiner 208 creates permutations using the historical 5^{th} and 95^{th} percentile of price gaps between two pairs of items and uses Monte Carlo simulations to calculate the net profit for the pair of items based on modeled performance at each price gap to identify the profit maximizing point. Additional details regarding the target price gaps are described in further detail below in connection with FIG. 13.

Additionally or alternatively, the pricing determiner 208 analyzes the recommended price strategy sub-lever. For example, the pricing determiner 208 determines a recommended price strategy based on a framework to compare everyday price elasticity (e.g., base price elasticity) and promoted price elasticity (e.g., promotional price intensity). In some examples, the pricing strategies include an everyday low price (EDLP) strategy, an options strategy, a high-shallow strategy, and a high-low strategy. Additional details regarding the pricing strategy framework are described in further below in connection with FIG. 14.

Additionally or alternatively, the pricing determiner 208 analyzes the everyday price threshold sub-lever. For example, the pricing determiner 208 determines everyday price thresholds using a multiplicative multiple regression model. That is, the pricing determiner 208 determines everyday price thresholds in a manner consistent with example Equation 1.

$$Sales = f ( Own Regular Price + Own Regular Price vs . Comp . + Own Promo Price + Own Promo Activity + Comp . Promo Activity + Seasonality + Store Effects + Random Term ) \qquad Equation 1$$

As described in example Equation 1, weekly item level volume (e.g., sales) is a function of a series of price and promotion variables (e.g., own product regular price, own product regular price vs. competitor product regular price, etc.). The example pricing determiner 208 tests the everyday price thresholds using the machine learning model to identify statistically significant price points where volume deviates from the expected model volume.

The example promotion determiner 210 determines target promotion principles based on one or more sub-levers. In some examples, the promotion determiner 210 includes means for determining target promotion principles (sometimes referred to herein as target promotion principles determining means). The example means for determining target promotion principles is hardware. For example, the promotion determiner 210 analyzes data stored in the data lake 204 to determine a target depth of discount, a target promotion frequency, a target timing of a promotion, target promoted price thresholds, target offer communication, target promotion support, etc. In some examples, the promotion determiner 210 determines a target value for the sub-levers based on a target return of investment (ROI).

For example, the promotion determiner 210 analyzes the target depth of discount sub-lever. In some examples, the promotion determiner 210 determines the target depth of discount range as the range between the profit-maximizing and break-even (e.g., a profit of $0.00) discount levels. For example, the promotion determiner 210 determines one or more limits in a manner consistent with example equations illustrated in Table 1.

TABLE 1
[Unit lift at X%] = ((1-X%) \hat{ } [Promo Elasticity] * [Weighted Multiplier] *
[Weekly Base Units]) − [Weekly Base Units]
[Dollar lift at X%] = ((1-X%) \hat{ } [Promo Elasticity] * [Weighted Multiplier]
* [Weekly Base Units] * ((1-X%) * [Base Price])) − [Weekly Base Dollars]
[Promo Cost at X%] * [Base Cost] − ([Base Price] * X%) * < Promo Funding Split>
[Promo Profit at X%] = ((1-X%) \hat{ } [Promo Elasticity] * [Weighted
Multiplier] * [Weekly Base Units] * ((1-X%) * [Base Price])) − (((1-X%) \hat{ }
[Promo Elasticity] * [Weighted Multiplier] * [Weekly Base Units]) *
[Promo Cost at X%])
[Profit lift at X%] = [Promo Profit at X%] − [Base Profit]

In examples disclosed herein, the promotion determiner 210 determines the limits of unit lift, dollar lift, promotion cost, promotion profit, and profit lift for depths of discounts from 1% to 99% (e.g., X %). However, the promotion determiner 210 can additionally or alternatively determine depths of discounts limits for any suitable percentage range (e.g., 5% to 95%, etc.). In some examples, the promotion determiner 210 stores the depth of discount limits in a table in the data lake 204.

The example promotion determiner 210 determines discount ranges in a manner consistent with example equations illustrated in Table 2.

```
TABLE 2
[Profit Maximizing Discount] = % Discount where [Profit lift at X%] =
MAX across PPG
[Break-Even Discount] = Last % Discount before [Profit lift at X%] = 0
across PPG
[Discount Range] = [Profit Maximizing Discount] to [Break-Even
Discount], where
  • IF [Profit lift at X%] < 0, Discount Range = 0-5% (default low)
  • IF [Profit lift at X%] > 0 (no Break-Even point exists), Discount
    Range = [Profit Maximizing Discount] to [Profit Maximizing
    Discount] + 10% (default high)
  • IF both [Profit Maximizing Discount] and [Break-Even Discount] <
    5%, Discount Range = 0-5% (default low)
  • IF both [Profit Maximizing Discount > 50% and [Break-Even
    Discount] > 50%, Discount Range = 40-50% (default high)
```

That is, the example promotion determiner 210 determines the profit maximizing discount and break-even discount based on the profit lift (e.g., determined in Table 1) across a promoted price group (PPG). In some examples, the promotion determiner 210 adjusts the target discount range based on the constraints illustrated in Table 2. However, the example promotion determiner 210 can use any suitable constraint (e.g., IF both [Profit Maximizing Discount>50% and [Break-Even Discount]>50%, Discount Range=30-60%, etc.).

Additionally or alternatively, the example promotion determiner 210 analyzes the promoted threshold sub-lever. For example, the promotion determiner 210 determines promoted thresholds in a manner consistent with example Equation 2.

$$Sales = f ( Own Regular Price + Own Regular Price vs Comp + Own Promo Price + Own Promo Activity + Comp . Promo Activity + Seasonality + Store Effects + Random Term ) \qquad Equation 2$$

In comparison with Equation 1, the promotion determiner 210 determines promoted thresholds based on promoted prices. For example, the difference between Own Promo Price and Own Regular Price (e.g., the discount) is a component of promoted sales.

Additionally or alternatively, the example promotion determiner 210 analyzes the timing sub-lever. For example, the promotion determiner 210 determines the optimal weeks of a promotion in a manner consistent with example equations illustrated in Table 3.

TABLE 3

[Weekly Base Units] = Σ Base Units over Category, Account, Week
[Week Rank] = rank descending over [Weekly Base Units]

In examples disclosed herein, the promotion determiner 210 determines the weekly base units by summing the Base Units for each of the 52 weeks of a year over Category, Account, and Week. In examples disclosed herein, Base Units refer to the number of products that would have been sold if there was no promotion of the product. However, the promotion determiner 210 additionally or alternatively sums the Base Units for any suitable number of weeks (e.g., 50 weeks, 104 weeks, etc.).

The example assortment determiner 212 determines target assortment principles based on POS data, consumer behavior data, etc. stored in the data lake 204. In some examples, the assortment determiner 212 includes means for determining target assortment principles (sometimes referred to herein as target assortment principles determining means). The example means for determining target assortment principles is hardware. For example, the assortment determiner 212 identifies one or more items to add and/or remove from in-person stores, items that can be eliminated from specific stores or all stores, etc. In some examples, the assortment determiner 212 analyzes an at-risk items sub-lever, an SKU rationalization sub-lever, an assortment optimization sub-lever, an assortment velocity sub-lever, etc. The example assortment determiner 212 determines a PowerRank of a product to identify the product's position in a retailer relative to internal competitors and/or external competitors. In examples disclosed herein, the PowerRank is a combination of z-scores from one or more assortment related metrics (e.g., total distribution points (TDP), cost, velocity, growth, retailer share, etc.). In some examples, the assortment related metrics are referred to as key performance indicators (KPIs). For example, the assortment determiner 212 determines z-scores for a retailer of interest (e.g., the focus retailer) and related retailers (e.g., retailers within a threshold distance from the focus retailer). The example assortment determiner 212 determines the z-score(s) in a manner consistent with example equations illustrated in Table 4.

TABLE 4
[TDP Z-Score] = ([TDP] − AVG(TDP) over Account, Category) /
STDEV(TDP) over Account, Category
[$ Z-Score] = ([$] − AVG($) over Account, Category) / STDEV($) over
Account, Category
[Velocity Z-Score] = ([Velocity] − AVG(Velocity) over Account, Category)
/ STDEV(Velocity) over Account, Category
[Growth Z-Score] = ([Growth] − AVG(Growth) over Account, Category) /
STDEV(Growth) over Account, Category
[Retailer Share Z-Score] = ([Retailer Share] − AVG(Retailer Share) over
Account, Category) / STDEV(Retailer Share) over Account, Category

In examples disclosed herein, the assortment determiner 212 determines the z-scores of the assortment related metrics over account and category. Additionally or alternatively, the assortment determiner 212 determines the z-scores of the assortment related metrics over a market level, item level, etc.

The example assortment determiner 212 determines the Item Rank of the focus retailer based on the z-score(s) in a manner consistent with example equations illustrated in Table 5.

TABLE 5
[Focus Score] = 0.35 * [$ Z-Score] + 0.2 * [TDP Z-Score] + 0.15
[Retailer Share Z-Score] + 0.1 * [Growth Z-Score] + 0.1 * [ROM Growth
Z-Score] + 0.1 * [Velocity Z-Score]
[ROM Score] = 0.35 * [ROM $ Z-Score] + 0.2 * [ROM TDP Z-Score] +
0.15 * [ROM Retailer Share Z-Score] + 0.15 * [ROM Growth Z-Score] +
0.15 * [Velocity Z-Score]

In examples disclosed herein, the assortment determiner 212 determines the Focus Score (e.g., corresponding to the focus retailer) and/or the rest of market (ROM) Score (e.g., corresponding to the related retailers) based on weighted z-scores of the KPIs (e.g., determined based on Table 4). In some examples, the assortment determiner 212 determines the Focus Score and/or the ROM score based on different weighted z-scores (e.g., 0.4*[$], 0.1*[TDP], etc.). Additionally or alternatively, the assortment determiner 212 determines the Focus Score and/or the ROM score based on percent ranks (e.g., percentages) of the TDP value, the $ value, the velocity value, the growth value, and the retailer share value.

The example assortment determiner 212 determines the Item Ranking Segment in a manner consistent with example equations illustrated in Table 6.

```
TABLE 6
Focus Item Rank = rank( ) over [Score] desc partition by [Category],
[Account]
ROM Item Rank = rank( ) over [ROM Score] desc partition by [Category],
[Account]
Item Score = [Focus Score] + [ROM Score]
Percent Item Rank = percentile_rank( ) over [Score] desc partition by
[Category], [Account]
Item Ranking Segment =
  • IF [Percent Item Rank] > 0.9 then ‘Best-in-Class’
  • IF [Percent Item Rank] between 0.5 and 0.9 then ‘Core’
  • IF [Percent Item Rank] between 0.2 and 0.5 then ‘At Risk’
  • IF [Percent Item Rank] < 0.2 then ‘Bottom 20%’
```

That is, the example assortment determiner 212 classifies the item based on the Percent Item Rank. In examples disclosed herein, the assortment determiner 212 identifies whether an item is “Best in Class,” “Core,” “At Risk,” or “Bottom 20%” based on the Percent Item Rank values. For example, the “Best in Class” label indicates the item is in the top 10% of items, the “Bottom 20%” label indicates the item is in the bottom 20% of items, etc. In some examples, the assortment determiner 212 determines the Item Ranking Segment based on other percentages (e.g., “Best in Class” corresponds to Percent Item Rank greater than 0.95, etc.). Additionally or alternatively, the assortment determiner 212 can determine any number of item ranking segments (e.g., 5 segments, 3 segments, etc.).

The example assortment determiner 212 determines the Assortment Status in a manner consistent with example equations illustrated in Table 7.

TABLE 7

```
Assortment Status =
  • IF L4W TDP > 0.05 and L52W TDP < 0.05 then ‘New’
  • IF L52W TDP > 0.8 then ‘High Distribution’
  • IF L52W TDP > 0.5 and L4W TDP > 0.5 then ‘Core’
  • IF L4W TDP < 0.05 and L52W TDP > 0.05 then ‘Delisted’
  • IF L4W TDP = 0 and L52W TDP < 0.05 then ‘Not Carried’
  • ELSE ‘Existed’
```

In examples disclosed herein, the assortment statuses of an item include “New,” “High Distribution,” “Core,” “Delisted,” “Not Carried,” and “Existed.” For example, the assortment determiner 212 determines the assortment status based on the TDP value of the item in the last four weeks (L4 W) and the TDP value of the item in the last 52 weeks (L52 W). For example, if the assortment determiner 212 determines the TDP value of the item in the last four weeks is greater than 0.05 but the TDP value of the item in the last 52 weeks is less than 0.05, the item is a “New” item. In some examples, the assortment determiner 212 determines the Assortment Status based on other TDP values (e.g., “High Distribution” corresponds to L52 W TDP>0.9, etc.). Additionally or alternatively, the assortment determiner 212 can determine any number of assortment statuses (e.g., 3 assortment statuses of “New,” “High Distribution,” and “Existed,” etc.).

In examples disclosed herein, the assortment determiner 212 flags products based on the Item Ranking Segment and the Assortment Status. For example, the assortment determiner 212 flags an item that is already carried (e.g., same attributes carried) and/or items that exceed retailer bounds (e.g., the size of the item exceeds a threshold size, the price of the item exceeds a threshold price, etc.). Thus, the assortment determiner 212 reduces the likelihood of recommending an item to a retailer that would not make a significant change (e.g., would not increase profits above 5%, etc.) and/or would not be accepted by the retailer. The example assortment determiner 212 determines an assortment action for a product in a manner consistent with example equations illustrated in Table 8.

```
TABLE 8
[Item Size] = total size
[Item Price] =
    • IF [Assortment Status] = ‘New’ or ‘Core’ or ‘High Distribution’
      then sum($) over UPC, Account, Time Period / sum(Units) over
      UPC, Account, Time Period
    • ELSE sum($) over UPC, Account ROM, Time Period / sum(Units)
      over UPC, Account ROM, Time Period
  [Item descriptor concat] = concat(list of key attributes selected for the
  category)
  [Item exclusion flag] =
    • IF COUNTIF([Item descriptor concat] =< item descriptor concat.)
      over Category, Account > 2 then ‘Similar product already carried’
        ○ Use >2 because 1 = the item itself, 2 = there is at least 1
            other item with the same attributes
    • IF [Item Size] > MAX([Item Size]) over Category, Account then
      ‘Size is greater than largest item carried’
    • IF [Item Price] > MAX([Item Price]) over Category, Account then
      ‘Price is greater than most expensive item carried’
    • ELSE NULL
  [Assortment Action] =
    • IF [Item exclusion flag] IS NOT NULL then ‘Maintain’
    • IF [Item Ranking Segment] = ‘Bottom 20%’ or ‘At Risk’
        ○ IF [Assortment Status] = ‘Delisted’ or ‘Not Carried’ or
            ‘Existed’ then ‘Maintain’
        ○ IF [Assortment Status] = ‘New’ or ‘Core’ or ‘High
            Distribution’ then ‘At Risk’
    • IF [Item Ranking Segment] = ‘Core’
        ○ IF [Assortment Status] = ‘Core’ or ‘High Distribution’ then
            ‘Maintain’
        ○ IF [Assortment Status] = ‘Delisted’ or ‘Not Carried’ then
            ‘Add’
        ○ IF [Assortment Status] = ‘New’ or ‘Existed’ then ‘Expand’
    • IF [Item Ranking Segment] = ‘Best-in-Class’
        ○ IF [Assortment Status] = ‘High Distribution’ then ‘Maintain’
        ○ IF [Assortment Status] = ‘Core’ or ‘New’ or ‘Existed’ then
            ‘Expand’
        ○ IF [Assortment Status] = ‘Delisted’ or ‘Not Carried’ then
            ‘Add’
```

In some examples, the assortment action flags include “Maintain,” “At Risk,” “Add,” and “Expand.” For example, the assortment determiner 212 determines whether to flag a product to maintain, flag a product as at risk of being delisted, flag a product to expand an amount being sold, flag a product to add to the existing products being sold, etc. However, the assortment determiner 212 can determine any suitable number of assortment actions based on any suitable Item Ranking Segment and/or Assortment Status.

The example new product determiner 214 determines a hurdle rate for one or more retailers based on retailer sale data stored in the data lake 204. As used herein, a hurdle rate is indicative of the sales required for a new product to be successful with that retailer. As used herein, a new product is an item that was first sold in the last 52 weeks. However, a new product can additionally or alternatively be an item first sold in the last 26 weeks, 78 weeks, etc. In some examples, the new product determiner 214 includes means for determining target new product principles (sometimes referred to herein as target new product principles determining means). The example means for determining target new product principles is hardware. For example, the new product determiner 214 analyzes a new product at-risk sub-lever, a new-product distribution sub-lever, a new product sales sub-lever, a new product velocity sub-lever, a new product fit sub-lever, a new product TDP upside sub-lever, a new product hit rate sub-lever, etc. The example new product determiner 214 classifies the new products into innovation buckets (e.g., categories, etc.) based on industry standard classification rules. For example, the new product determiner 214 classifies new products into a new brand bucket, a new flavor current brand bucket, etc. In examples disclosed herein, the new product determiner 214 analyzes innovation buckets to determine which features of innovation drive growth for new products. For example, in a certain category, “Organic” is a product feature that is growing significantly with respect to other product features (e.g., genetically modified organism (GMO) products, etc.). Thus, the “New Organic” innovation bucket indicates how helpful it is for a new item to be organic (e.g., to increase sales in a given category and market).

In examples disclosed herein, the new product determiner 214 determines which retailers and/or stores first introduce new products and identifies the minimum rate of sale for an item to be launched in those stores based on historical new products. For example, the new product determiner 214 determines to introduce a new product in a specific retail store based on demographic data of shoppers of that retail store and a comparison of the hurdle rate for that store versus the expected sales of the new product. If the expected sales of the new product is higher than the hurdle rate and a product currently on the shelf can be found to be removed such that the sales of the new product is greater than the lost sales from delisting the product, the new product determiner 214 will identify that store as an opportunity for the new product.

For example, the new product determiner 214 determines a risk index for new products. As used herein, a risk index measures the possibility of de-listing the new product based on the performance metrics (e.g., velocity, price, TDP, etc.) relative to the remainder of the category. The example new product determiner 214 determines the risk index in a manner consistent with example equations illustrated in Table 9.

TABLE 9
[Velocity Score] = Percentile_Rank(over [Velocity] asc ) partition by
Account, Category
[$ Score] = Percentile_Rank(over [$] asc ) partition by Account, Category
[TDP Score] = Percentile_Rank(over [TDP] asc ) partition by Account,
Category
[Risk Score] = 0.5 * [Velocity Score] + 0.3 * [$ Score] + 0.2 * [TDP Score]
[Risk Index] = 100 * [Risk Score] / AVG([Risk Score]) over Account,
Category

In some examples, the new product determiner 214 determines the Risk Score and/or Risk Index score based on different weights (e.g., 0.4*[Velocity Score], etc.) In examples disclosed herein, the rank of the performance metrics are sorted in ascending order such that a low performance indicates a high risk. In some examples, the new product determiner 214 flags new products as ‘at risk’ if they are above a threshold amount of distribution and in the bottom 20^{th} percentile of items based on the risk score.

The example in-store execution determiner 216 determines a net category incremental value of how and/or where a product is displayed. In some examples, the in-store execution determiner 216 includes means for determining target execution principles (sometimes referred to herein as target execution principles determining means). The example means for determining target execution principles is hardware. That is, circular ads (e.g., weekly advertisements, etc.) and/or in-store displays have limited capacity. Thus, the in-store execution determiner 216 determines a mix of products to display and/or include in weekly advertisements based on the net category incremental value of each product versus other alternatives for that space such that total sales from the display and/or weekly advertisements are maximized. For example, the in-store execution determiner 216 determines a feature net incremental value, a display net incremental value, and/or a feature and display net incremental value to identify the value the product brings when securing execution support (e.g., when included in a display, weekly advertisement, etc.). The example in-store execution determiner 216 determines the incremental values in a manner consistent with example equations illustrated in Table 10.

TABLE 10
[TPR Incremental] = (([PPG Promo Price] / [PPG Base Price]) \hat{ } [PPG
Promo Elasticity]) * [PPG Base Units] * [PPG Promo Price]) − [PPG Base
Dollars] * % Category Incremental
[Feature Incremental] = (([PPG Promo Price] / [PPG Base Price]) \hat{ } [PPG
Promo Elasticity]) * [PPG Feature Multiplier] * [PPG Base Units] * [PPG
Promo Price]) − [PPG Base Dollars] * % Category Incremental
[Display Incremental] = (([PPG Promo Price] / [PPG Base Price]) \hat{ } [PPG
Promo Elasticity]) * [PPG Display Multiplier] * [PPG Base Units] * [PPG
Promo Price]) − [PPG Base Dollars] * % Category Incremental
[Feat+Disp Incremental] = (([PPG Promo Price] / [PPG Base Price]) \hat{ }
[PPG Promo Elasticity]) * [PPG Feat+Disp Multiplier] *
[PPG Base Units] *
[PPG Promo Price]) − [PPG Base Dollars] * % Category Incremental

In some examples, the in-store execution determiner 216 ranks the metrics (e.g., the TPR incremental, the feature incremental, the display incremental, and/or the feature+display incremental) across all PPGs in the category to determine the value of the product on promotion. That is, the in-store execution determiner 216 determines a lift rank. The in-store execution determiner 216 compares the lift rank to the current execution support rank (e.g., frequency rank) to identify items that are getting more or less than the target level of support. For example, the current execution support rank is based on how many weeks of promotions a given PPG receives in a time period. The example in-store execution determiner 216 ranks the current execution support rank of the given PPG against other PPGs in the same category, market, and/or period to determine which PPGs are receiving the most support, the least support, etc. For example, the current execution support rank of a product should be the same as the performance rank for category optimization. In examples disclosed herein, the in-store execution determiner 216 determines the performance rank based on the incrementals determined in Table 10 (e.g., the TPR Incremental, the Feature Incremental, the Display Incremental, and/or the Feature+Display Incremental). Thus, if the performance rank of an item is 0.75 (e.g., the item perform better than 75% of the items in the PPG set), the number of weeks should be a value that results in the 75% percentile of all items in the set. That is, the in-store execution determiner 216 analyzes the current execution support rank and the performance rank based on promotion type (e.g., TPR, Feature, Display, Feature+Display, etc.). For example, the in-store execution determiner 216 compares the TPR performance rank for PPGs with the TPR frequency rank for the PPGs, the in-store execution determiner 216 compares the Feature performance rank to the Feature frequency rank, etc.

In the illustrated example of FIG. 2, the action determiner 114 includes an example execution analyzer 218. In some examples, the execution analyzer 218 includes means for comparing data (sometimes referred to herein as data comparing means). The example means for comparing data is hardware. The example execution analyzer 218 analyzes real-time market data (e.g., POS data, etc.) to identify products in which the in-market strategies and executions differ from the target principles determined by the example target principle generator 206. That is, in some examples, the execution analyzer 218 analyzes the real-time market data based on the levers analyzed by the target principle generator 206 (e.g., the pricing lever, the promotion lever, the assortment lever, the new product lever, and/or the execution lever). However, the execution analyzer 218 can analyze the real-time market data based on any suitable lever and/or sub-lever analyzed by the target principle generator 206. In the illustrated example of FIG. 2, the execution analyzer 218 includes an example pricing analyzer 220, an example promotion analyzer 222, an example assortment analyzer 224, an example new product analyzer 226, and an example execution analyzer 228 (sometimes referred-to as an in-store execution analyzer 228).

The example pricing analyzer 220 compares the real-time market data to the target price principle determined by the pricing determiner 208. In some examples, the pricing analyzer 220 includes means for analyzing pricing data (sometimes referred to herein as pricing data analyzing means). The example means for analyzing pricing data is hardware. For example, the pricing analyzer 220 analyzes the real-time market data with respect to the price gap sub-lever, the price threshold sub-lever, and/or the price strategy sub-lever. The example pricing analyzer 220 analyzes the real-time market data in a manner consistent with example Table 11.

TABLE 11

| Lever | Sub-Lever | Target | Flag Criteria |
|---|---|---|---|
| Price | Gap | Gap between focus | 1) Gap more than 10% |
| | | product and | higher than optimal and |
| | | competitive product at | highly elastic then |
| | | profit maximizing gap | reduce price |
| | | and/or optimal price | 2) Gap more than 10% |
| | | ladder | below optimal and |
| | | | inelastic then increase |
| | | | price |
| | | | 3) If products of larger |
| | | | size have smaller price |
| | | | per unit (i.e., a 12 OZ |
| | | | product is more |
| | | | expensive per ounce |
| | | | than a 6 OZ product), |
| | | | flag product as off of |
| | | | price ladder |
| | Threshold | Meet or exceed | 1) High elasticity items |
| | | everyday threshold | above threshold = |
| | | | Lower Price to |
| | | | threshold |
| | | | 2) Low elasticity items |
| | | | below threshold = |
| | | | Raise to threshold |
| | Strategy | Current pricing strategy | If current <> Optimal |
| | | equal to optimal pricing | flag and recommend |
| | | strategy | move to optimal |
| | | | strategy with |
| | | | description of how to |
| | | | make the move |
| | Price | Have a competitive | 1) If percentile of price |
| | Position | price position in the | in the category is high |
| | | category | (e.g., >80%) and item is |
| | | | elastic = Lower price to |
| | | | be competitive |
| | | | 2) If percentile of price |
| | | | in the category is low |
| | | | (e.g., <20%) and item |
| | | | is inelastic = increase |
| | | | price to save margin |
| | Velocity | Velocity should be | If everyday velocity is |
| | | competitive in the | lower than the category |
| | | category | average, flag as low |
| | | | performance |
| | Historical | Price changes made in | 1) Price has been |
| | Price | the last year should be | reduced for inelastic |
| | Change | aligned to strategy | item or cannibalistic |
| | | | item = bad price change |
| | | | 2) Price has been |
| | | | increased for elastic |
| | | | item = bad price change |

For example, the pricing analyzer 220 analyzes the price gap sub-lever to determine whether the gap between the product and competitor product is above or below a price gap threshold (e.g., the price gap threshold corresponding to conditions deemed “optimal”). For example, the pricing analyzer 220 determines whether the gap between the product and the competitor product is 10% higher than the target price gap. In some examples, the pricing analyzer 220 determines flag criteria based on alternative thresholds than those illustrated in Table 11 (e.g., gap more than 15%, etc.). In some examples, both the pricing determiner 208 and the pricing analyzer 220 are constantly monitoring real-time market data and making changes to the target principle determined by the pricing determiner 208 and the compliance determined by the pricing analyzer 220.

The example promotion analyzer 222 compares the real-time market data to the target promotion principle determined by the example promotion determiner 210. In some examples, the promotion analyzer 222 includes means for analyzing promotion data (sometimes referred to herein as promotion data analyzing means). The example means for analyzing promotion data is hardware. For example, the promotion analyzer 222 analyzes the real-time market data with respect to the promotion depth sub-lever, the promotion timing sub-lever, and the promotion thresholds sub-lever based on example Table 12.

TABLE 12

| Lever | Sub-Lever | Target | Flag Criteria |
|---|---|---|---|
| Promotion | Depth | Between profit | Current depth outside |
| | | maximizing and | of range |
| | | breakeven depth of | |
| | | discount | |
| | Timing | Best offer (e.g. greatest | More than 10% MAPE |
| | | depth of discount and | deviation from optimal |
| | | most execution | ranking |
| | | support) aligned to best | |
| | | week, 2^{nd} best offer to | |
| | | 2^{nd} best week, etc. | |
| | Thresholds | Meet or exceed | 1) High elasticity items |
| | | promoted threshold | above threshold = |
| | | | Lower Price to |
| | | | threshold |
| | | | 2) Low elasticity items |
| | | | below threshold = |
| | | | Raise to threshold |
| | Support | Quality support (e.g., | More than 10 point |
| | | feature, display, etc.) is | deviation of |
| | | allocated to the best | performance rank (e.g., |
| | | items | percent rank of an |
| | | | item's lift on a type of |
| | | | support) from support |
| | | | rank (e.g., percentile |
| | | | rank of the number of |
| | | | weeks that item |
| | | | receives on that type of |
| | | | support) |

For example, the promotion analyzer 222 analyzes the depth sub-lever to determine whether the promotion depth between the target profit and the breakeven depth is outside a range (e.g., 5%-12%, etc.). The promotion analyzer 222 can also determine whether the promotion is being run on the optimal week. In some examples, both the promotion determiner 210 and the promotion analyzer 222 are constantly monitoring real-time market data and making changes to the target principle determined by the promotion determiner 210 and the compliance determined by the promotion analyzer 222.

The example assortment analyzer 224 compares the real-time market data to the target assortment principle determined by the example assortment determiner 212. In some examples, the assortment analyzer 224 includes means for analyzing assortment data (sometimes referred to herein as assortment data analyzing means). The example means for analyzing assortment data is hardware. For example, the assortment analyzer 224 analyzes the real-time market data with respect to assortment risk of an item being delisted, assortment SKU rationalization to identify items that can be delisted across all retailers, and assortment distribution opportunity to identify items to add at specific retailers based on example Table 13.

TABLE 13

| Lever | Sub-Lever | Target | Flag Criteria |
|---|---|---|---|
| Assort- | At-Risk | Risk index in top 80% | If item in distribution |
| ment | | of items carried by | and in the bottom 20% |
| | | retailer | of all items in the |
| | | | category |
| | SKU | Account level item | 1) If item in the bottom |
| | Rationalization | rank in the top 20% of | 20% of items in more |
| | | items across majority | than 20% of accounts |
| | | of accounts and/or | 2) Item's index (e.g., |
| | | above the category | score/average score) is |
| | | average in given | below 90 |
| | | account | |
| | Distribution | High performing item | If item in the top 30% |
| | Opportunity | in distribution in the | of items in the market |
| | | market without a | and not carried at |
| | | comparable item at | retailer and retailer does |
| | | focus retailer and/or | not have a comparable |
| | | high performing in the | product |
| | | market with | And/or item |
| | | opportunity to expand | performance scores |
| | | | >10 points higher than |
| | | | the item's distribution |
| | | | rank |
| | Velocity | Velocity should be | If everyday velocity is |
| | | competitive in the | lower than the category |
| | | category | average, flag as low |
| | | | performance |

For example, the assortment analyzer 224 analyzes the at-risk sub-lever to determine the risk of an item being delisted by comparing the sales of a given item to the threshold for an item to be in the bottom 20% of items carried by the retailer across sales, growth and other key metrics. In some examples, the assortment analyzer 224 determines flag criteria based on alternative thresholds than those illustrated in Table 13 (e.g., distribution in the bottom 10%, etc.). Additionally or alternatively, the assortment analyzer 224 determines whether a high performing item (e.g., an item with a number of sales over a threshold) is carried at a retailer and/or whether that retailer has a comparable item (e.g., a competitor product, etc.) and if the retailer does not carry a comparable item, the assortment analyzer 224 will recommend that item to be added by the retailer. In some examples, the assortment determiner 212 and the assortment analyzer 224 are constantly monitoring real-time market data and making changes to the target principle determined by the assortment determiner 212 and the compliance determined by the assortment analyzer 224.

The new product analyzer 226 compares the real-time market data to the target new product principle determined by the example new product determiner 214. In some examples, the new product analyzer 226 includes means for analyzing new product data (sometimes referred to herein as new product data analyzing means). The example means for analyzing new product data is hardware. For example, the new product analyzer 226 analyzes the real-time market data with respect to the new product risk sub-lever based on Table 14.

TABLE 14

| Lever | Sub-Lever | Target | Flag Criteria |
|---|---|---|---|
| New | At-Risk | Risk index in top 80% | If new product in |
| Product | | of items carried by | distribution and in the |
| | | retailer | bottom 20% of all |
| | | | items in the category |
| | Distribution | New item should be | Distribution at current |
| | | gaining distribution | number of weeks in the |
| | | comparable to other | market is below |
| | | new items | average distribution for |
| | | | new items at the same |
| | | | number of weeks in the |
| | | | market |
| | Sales | New item should be | Sales at current number |
| | | gaining sales | of weeks in the market |
| | | comparable to other | is below average sales |
| | | new items | for new items at the |
| | | | same number of weeks |
| | | | in the market |
| | Velocity | New item velocity | 1) New item velocity < |
| | | should be competitive | at-risk items velocity = |
| | | | low |
| | | | 2) New item velocity < |
| | | | average velocity = low |
| | | | 3) New item velocity > |
| | | | best-in-class velocity = |
| | | | high |
| | Fit | Items were introduced | Fit Score >75% = High |
| | | to optimal markets | Fit Score between 50- |
| | | | 75% = Moderate |
| | | | Fit Score <50% = Low |
| | TDP | There should be room | 1) If (Target % |
| | Upside | for distribution growth, | Distribution-Current |
| | | but not too much as | % Distribution) is in |
| | | that indicates a lack of | the top 10% of the |
| | | growth already | category, then flag |
| | | | “distribution is lagging, |
| | | | need to gain a lot of |
| | | | distribution still” |
| | | | 2) If (Current % |
| | | | Distribution-Target % |
| | | | Distribution) is in the |
| | | | top 10% of the |
| | | | category, then flag “not |
| | | | a lot of growth |
| | | | opportunity left” |
| | Hit Rate | Stores across the | % of Stores in retailer |
| | | retailer are selling the | carrying the item is in |
| | | new item | the bottom 20% |

In some examples, the new product analyzer 226 determines whether a new product is at risk of being delisted due to having performance in the bottom 20% of items carried by the retailer. In some examples, the new product analyzer 226 determines flag criteria based on alternative thresholds than those illustrated in Table 14 (e.g., distribution in the bottom 10%, etc.). In some examples, the new product determiner 214 and the new product analyzer 226 are constantly monitoring real-time market data and making changes to the target principle and the compliance determined by the new product analyzer 226.

The example execution analyzer 228 compares the real-time market data to the target execution principle determined by the example in-store execution determiner 216. In some examples, the execution analyzer 228 includes means for analyzing execution data (sometimes referred to herein as execution data analyzing means). The example means for analyzing execution data is hardware. For example, the execution analyzer 228 analyzes the real-time market data with respect to fair share of support of the product based on Table 15.

TABLE 15

| Lever | Sub-Lever | Target | Flag Criteria |
|---|---|---|---|
| Execution | Fair share | Support lift rank = | 1) If support lift rank |
| | of support | support execution rank | >1.1% support execution |
| | | | rank then increase |
| | | | support |
| | | | 2) If support lift rank |
| | | | <0.9* execution rank |
| | | | then decrease support |

In some examples, the execution analyzer 228 determines whether the support lift rank of the product exceeds the support that the product is receiving and reallocates support from lesser performing items to higher performing items. In some examples, the execution analyzer 228 determines flag criteria based on alternative thresholds than those illustrated in Table 15 (e.g., support lift rank>5%, etc.). In some examples, the in-store execution determiner 216 and the execution analyzer 228 are constantly monitoring real-time market data and making changes to the target principle determined by the in-store execution determiner 216 and the compliance determined by the execution analyzer 228.

In the illustrated example of FIG. 2, the action determiner 114 includes an example score generator 230. In some examples, the score generator 230 includes means for determining a score (sometimes referred to herein as score determining means). The example means for determining a score is hardware. The example score generator 230 determines a score for the product(s) and/or account(s) based on the compliance to the target principles determined by the example execution analyzer 218. For example, the score generator 230 determines aggregate scores for each lever (e.g., price, promotion, assortment, new product execution, etc.) up a product and market hierarchy. For example, the score generator 230 organizes the aggregate scores in descending order, ascending order, etc. to prioritize opportunities for the market analyst. In some examples, the score generator 230 assigns a letter grade (e.g., A+, A, A−, etc.) and/or a number (e.g., 0-100) to the aggregate score.

In some examples, the score generator 230 identifies a best in class brand benchmark (e.g., Best in Class) for each sub-lever within the focus brand category (e.g., a focus brand sub-lever score). In some examples, the score generator 230 identifies the best in class brand based on the value required to be two standard deviations above the mean. However, the score generator 230 can determine the best in class brand benchmark in any suitable manner (e.g., one standard deviation above the mean, etc.). The example score generator 230 benchmarks the focus brand sub-lever score to the best in class score for the corresponding sub-lever to create an index. The example score generator 230 determines scores for the sub-lever in a manner consistent with example Table 16.

TABLE 16

• IF [Focus Brand] ≥ [Best in Class], then 1 (A+)
• IF [Focus Brand] ≥ 0.9*[Best in Class], then 0.9 (A)
• IF [Focus Brand] ≥ 0.8*[Best in Class], then 0.8 (B)
• IF [Focus Brand] ≥ 0.7*[Best in Class], then 0.7 (C)
• IF [Focus Brand] ≥ 0.5*[Best in Class], then 0.6 (D)
• IF [Focus Brand] ≥ 0*[Best in Class], then 0.5 (F)
• IF [Focus Brand] < 0, then 0 (F−)

In examples disclosed herein, the score generator 230 assigns scores (e.g., 1, 0.9, 0.8) to the sub-lever based on the Focus Brand score and the Best in Class thresholds. However, the example score generator 230 can use any Best in Class thresholds (e.g., IF [Focus Brand]>0.95*[Best in Class], then 0.9 (A), IF [Focus Brand]>0.6*[Best in Class], then 0.6 (D), etc.). The example score generator 230 averages the sub-lever scores based on a sub-lever importance weighting to generate a lever score. The example score generator 230 aggregates the lever scores (e.g., averages the lever scores) across the product and/or market dimensions to generate a product score, a market score, etc. The example scoring process is described in further detail below in connection with FIG. 5.

In the illustrated example of FIG. 2, the output generator 232 generates one or more alerts for output by the action determiner 114 based on the analysis of the real-time market data by the target principle generator 206 and the execution analyzer 218. In some examples, the output generator 232 includes means for generating an output (sometimes referred to herein as output generating means). The example means for generating an output is hardware. That is, the output generator 232 generates an output including the one or more scores determined by the score generator 230. For example, the output generator 232 generates an alert (e.g., an email, etc.) to send to a user highlighting opportunities based on the scores (e.g., products with a C grade or lower, products with a score of less than 70, etc.). Additionally or alternatively, the output generator 232 generates a report card, intelligent dashboard, etc. including aggregate report cards by market, brand, etc. of the opportunities of each product. Additionally or alternatively, the output generator 232 provides a recommended adjustment of a lever for the user to execute. For example, the output generator 232 generates the report 116 (FIG. 1) to display on the user device 118 (FIG. 1). In some examples, the output generator 232 causes a change in an advertised price of the product, releases an advertisement for broadcast having the updated price, etc. In still other examples, the output generator 232 generates control instructions to cause an advertisement, cause a price change in a retailer computer system, cause a temporary price change in a market of interest, etc.

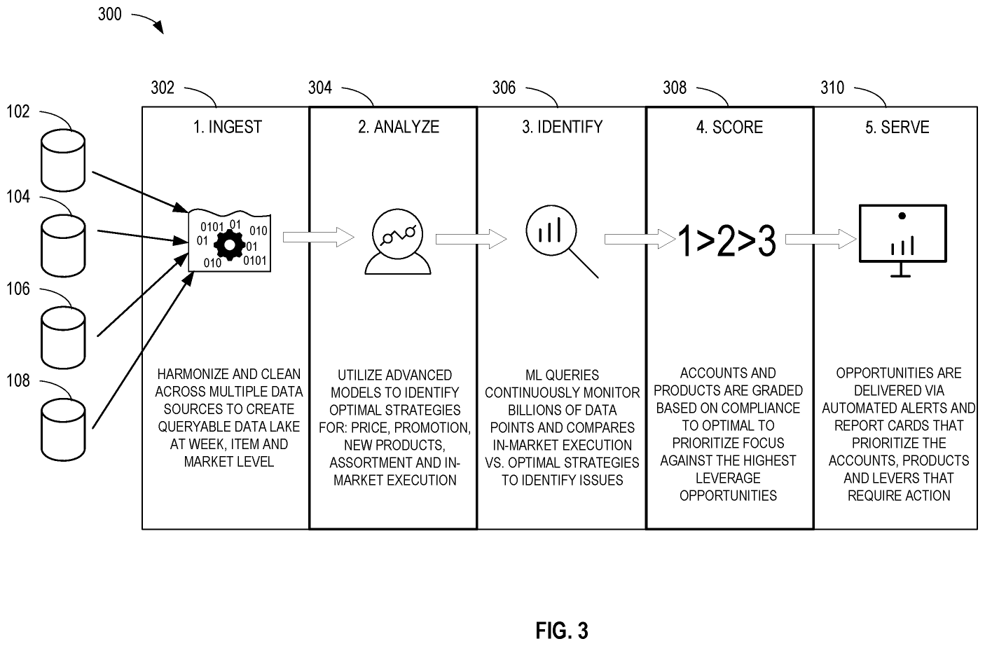

FIG. 3 illustrates an example market strategy identification architecture 300. The example market strategy identification architecture 300 includes an example ingest phase 302, an example analyze phase 304, an example identify phase 306, an example score phase 308, and an example serve phase 310. In examples disclosed herein, the example action determiner 114 (FIG. 1) implements the example market strategy identification architecture 300. For example, the data accessor 202 (FIG. 2) obtains data in the ingest phase 302. In some examples, the data accessor 202 obtains data from the example client databases 102, 104, 106, 108 (FIG. 1) to generate the example data lake 204 (FIG. 2).

In the example analyze phase 304, the example target principle generator 206 (FIG. 2) determines target principles for one or more levers (e.g., price, promotion, new products, assortment, in-market execution, etc.). In the example identify phase 306, the example execution analyzer 218 (FIG. 2) compares the target principles to in-market execution data to identify levers that are out of compliance. In the example score phase 308, the example score generator 230 (FIG. 2) generates scores for the levers based on whether the levers are out of compliance. For example, the score generator 230 aggregates the lever scores to generate account scores and/or market scores. That is, the example score generator 230 identifies levers with the highest opportunity to optimize market strategies (e.g., levers with relatively low scores). In the example serve phase 310, the output generator 232 (FIG. 2) generates a report to display to a market analyst (e.g., the example report 116 of FIG. 1). For example, the output generator 232 generates a report card displaying the levers of the account and/or product that require action (e.g., are out of compliance with the target principles).

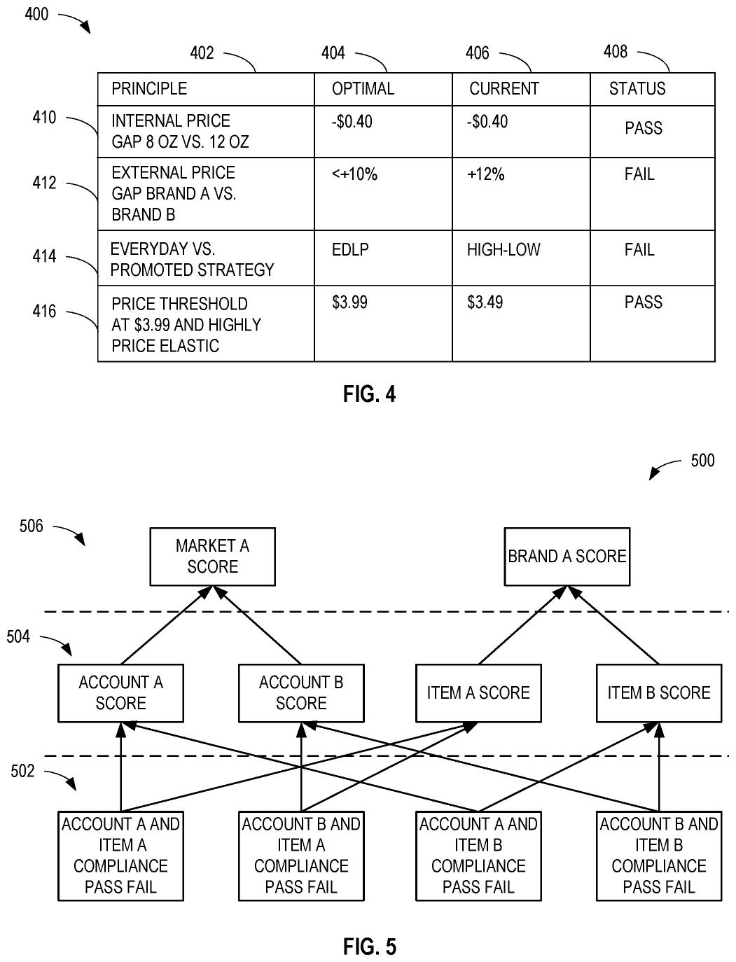

FIG. 4 illustrates example point of sale data 400 used by the example system of FIG. 1 to identify an action for a marketing strategy. The example point of sale data 400 includes example principles 402, example optimal principles 404, example in-market data 406, and example status indicators 408. In the illustrated example of FIG. 4, the principles 402 are sub-levers. For example, the principles 402 include an example internal price gap sub-lever 410, an example external price gap sub-lever 412, an example price strategy sub-lever 414, and an example price threshold sub-lever 416. In examples disclosed herein, the example target principle generator 206 (FIG. 2) determines the optimal principles 404 for the principles 402. For example, the pricing determiner 208 (FIG. 2) analyzes the internal price gap sub-lever 410 to determine the optimal principle (e.g., the optimal principles 404) of the price gap between an 8 ounce product and a 12 ounce product is $0.40.

The example execution analyzer 218 (FIG. 2) analyzes POS data to determine the in-market data 406 for the principles 402. For example, the pricing analyzer 220 (FIG. 2) analyzes the internal price gap sub-lever 410 to determine in-market execution data of the price gap between the 8 ounce product and the 12 ounce product is $0.40. The example execution analyzer 218 determines the example status indicators 408 of the principles 402 based on a comparison of the optimal principles 404 and the in-market data 406. For example, the pricing analyzer 220 determines the status indicator of the internal price gap sub-lever 410 is a ‘Pass’ (e.g., $0.40=$0.40). In some examples, the pricing analyzer 220 determines the status indicators 408 based on Table 11.

Additionally or alternatively, the pricing determiner 208 determines the optimal principle for the external price gap sub-lever 412 is a price gap less than 10% between Brand A and Brand B. The example pricing analyzer 220 determines the in-market execution data of the price gap between Brand A and Brand B is 12%. Thus, the pricing analyzer 220 determines the status indicator of the external price gap sub-lever 412 is a ‘Fail’ (e.g., 12%>10%).

FIG. 5 illustrates an example score aggregation architecture 500. The example score aggregation architecture 500 includes an example first aggregation level 502, an example second aggregation level 504, and an example third aggregation level 505. In the illustrated example of FIG. 5, the first aggregation level 502 includes account and item compliance indicators (e.g., with the optimal principles determined by the target principle generator 206 of FIG. 2). For example, the first aggregation level 502 is based on the status indicators 408 of FIG. 4 (e.g., ‘Pass’ or ‘Fail’). For example, the first aggregation level 502 includes an Account A and Item A compliance indicator, an Account B and Item A compliance indicator, an Account A and Item B compliance indicator, and an Account B and Item B compliance indicator.

The example score generator 230 (FIG. 2) generates scores included in the example second aggregation level 504. In the illustrated example of FIG. 5, the second aggregation level 504 includes an Account A score, an Account B score, an Item A score, and an Item B score. For example, the score generator 230 generates the Account A score based on the Account A and Item A compliance indicator and the Account A and Item B compliance indicator of the first aggregation level 502. In examples disclosed herein, the score generator 230 determines the scores of the second aggregation level 504 using z-scores.

The example score generator 230 generates scores included in the example third aggregation level 506. In the illustrated example of FIG. 5, the third aggregation level 506 includes a Market A score and a Brand A score. For example, the score generator 230 aggregates scores included in the second aggregation level 504. For example, the score generator 230 generates the Market A score based on the Account A score and the Account B score and generates the Brand A score based on the Item A score and the Item B score. In some examples, the output generator 232 converts the scores of the third aggregation level 506 to a letter and/or number grade to include in a report.

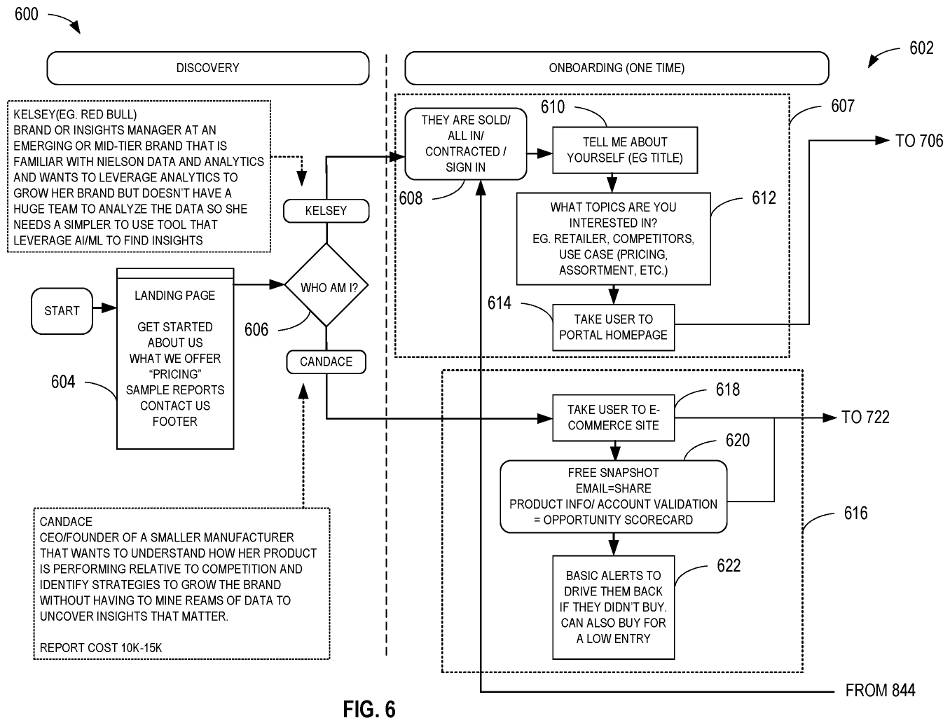

FIGS. 6-8 illustrate an example market strategy workflow for market analysts. FIG. 6 includes an example discovery phase 600 and an example onboarding phase 602. The example discovery phase 600 includes a first market analyst, Kelsey, and a second market analyst, Candace. For example, Kelsey and/or Candace access an example landing page 604. In some examples, the landing page 604 includes an overview of the example market strategy identification architecture 300 of FIG. 3, sample reports, etc. At block 606, the example action determiner 114 (FIG. 1) receives a user identifier. For example, the action determiner 114 can receive a first user identifier associated with Kelsey and a second user identifier associated with Candace.

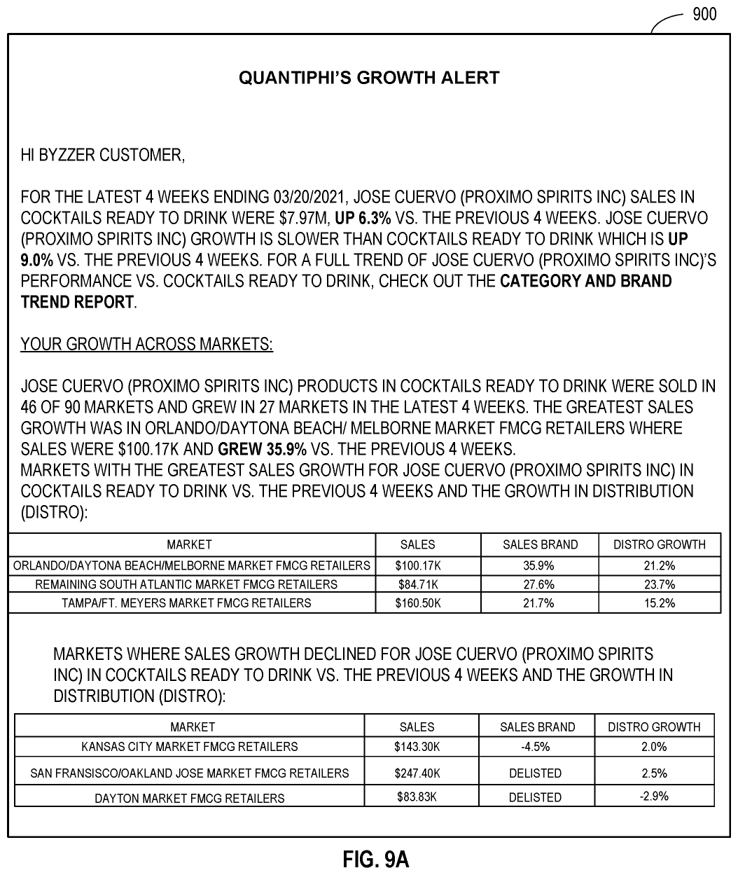

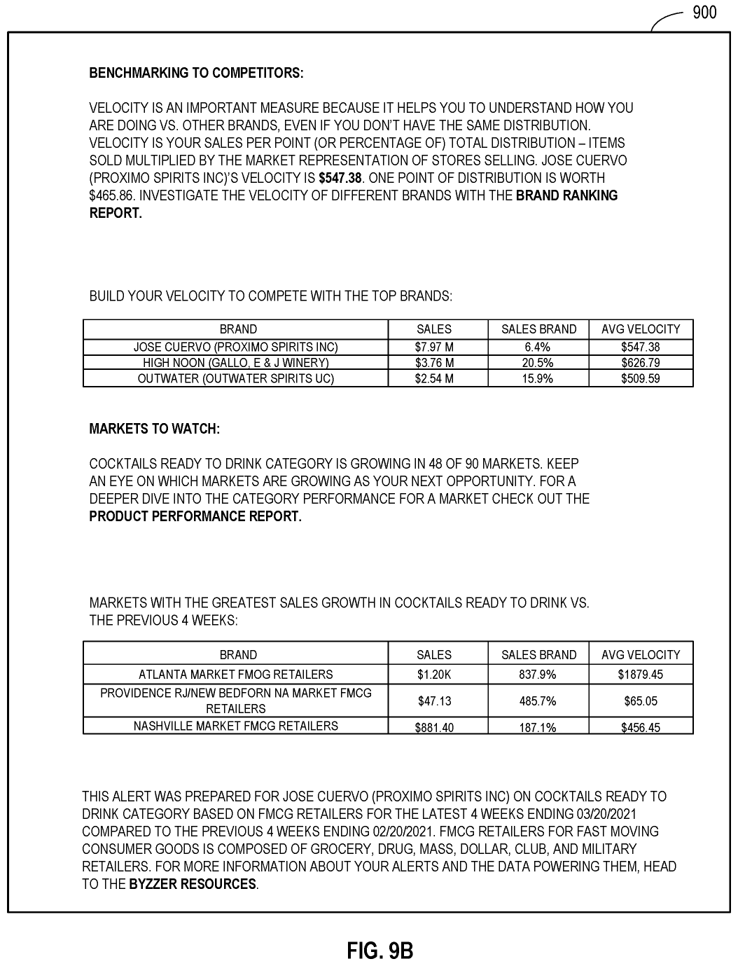

In the illustrated example of FIG. 6, the market strategy workflow includes the example onboarding phase 602. For example, the action determiner 114 obtains additional information associated with the market analysts. In some examples, the onboarding phase 602 occurs one time. Additionally or alternatively, the onboarding phase 602 is repeated (e.g., once a year, in response to a query, etc.). In some examples, the onboarding phase 602 is based on the user identifier (e.g., received at block 606). The illustrated example of FIG. 6 includes an example first onboarding process 607 corresponding to Kelsey. At block 608, the action determiner 114 receives an onboarding indication (e.g., a signed contract, etc.). At block 610, the action determiner 114 receives background information of the market analyst. For example, the market analyst can receive a prompt with the message “Tell Me About Yourself” In some examples, the background information includes the title of the market analyst, etc. At block 612, the action determiner 114 receives topics of interest. For example, the market analyst can receive a prompt with the message “What Topics Are You Interested In?” In some examples, the topics of interest include retailers, competitors, use cases (e.g., pricing, assortment, etc.). At block 614, the user device 118 (FIG. 1) displays a homepage. The homepage is described in further detail below in connection with FIGS. 9-12.

The illustrated example of FIG. 6 includes an example second onboarding process 616 corresponding to the second market analyst, Candace. In some examples, the second onboarding process 616 corresponds to a limited version of the market strategy identification architecture 300 (e.g., a free version, a lite version, etc.). At block 618, the example user device 118 displays an e-commerce site. At block 620, the example user device 118 displays a free snapshot. For example, the free snapshot includes an opportunity scorecard. In some examples, the opportunity scorecard includes less features with respect to the homepage displayed at block 614. At block 622, the example user device 118 displays basic alerts.

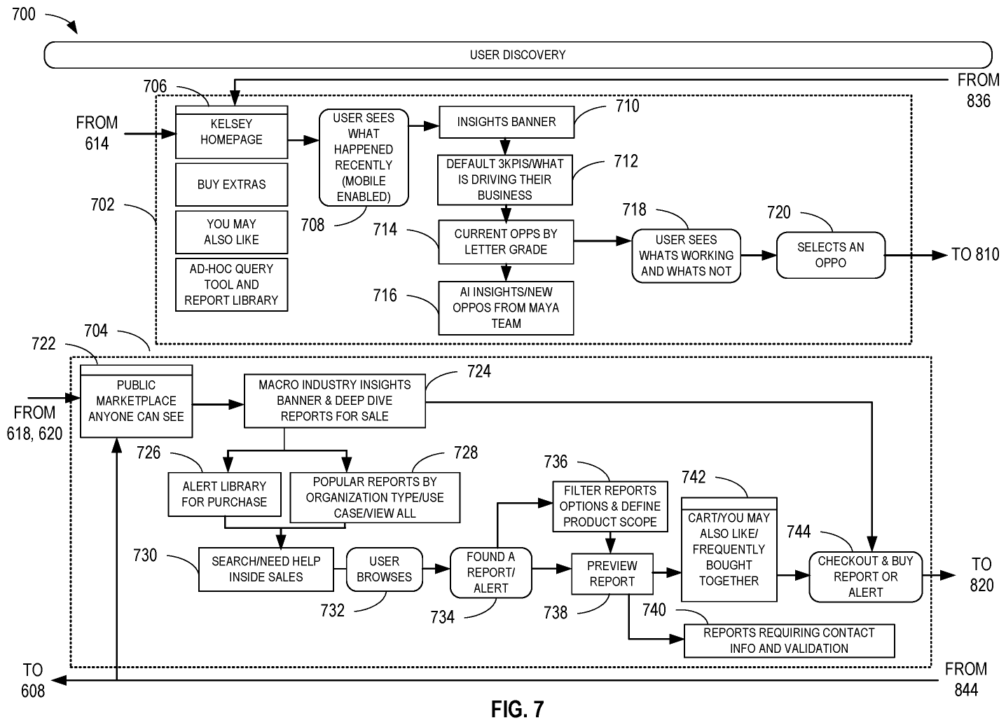

FIG. 7 includes an example user discovery phase 700. The example user discovery phase 700 includes an example first user discovery phase 702 and an example second user discovery phase 704. The example first user discovery phase 702 corresponds to the first market analyst (e.g., Kelsey) and the example second user discovery phase 704 corresponds to the second market analyst (e.g., Candace). For example, the user device 118 (FIG. 1) displays an example first homepage 706. In some examples, the example first homepage 706 displays an option to buy extras (e.g., a report including sales trends for a given time period, report cards for multiple categories, etc.), a “You May Also Like” section, an ad-hoc query tool and report library, etc. At block 708, the user device 118 displays a report. For example, the report includes current events (e.g., recent sales, new products, etc.). In some examples, the report includes an example insights banner 710, an example driving force report 712, an example grade report 714, and/or an example insight report 716. For example, the driving force report 712 includes default KPIs (e.g., what is driving business). In some examples, the grade report 714 and the insight report 716 include levers (e.g., price, promotion, etc.). That is, the user device 118 displays a report generated by the example action determiner 114 to identify an action for the first market analyst's topic of interest (e.g., defined in block 612 of FIG. 6).

At block 718, the first market analyst views the report (e.g., the insights banner 710, the driving force report 712, the grade report 714, and/or the insights report 716). For example, the first market analyst can determine market strategies that are working (e.g., levers with a relatively high grade) and market strategies that are not working (e.g., levers with a relatively low grade). At block 720, the first market analyst selects an opportunity. For example, the first market analyst selects a lever with a relatively low grade. For example, the first market analyst selects a first opportunity with a score of “C” and does not select a second opportunity with a score of “A”.

The example second user discovery phase 704 corresponds to the second market analyst. The example user device 118 displays an example public marketplace 722. For example, the public marketplace 722 includes information related to the second market analyst (e.g., based on the user identifier of the second market analyst). In some examples, the public marketplace 722 is available to the public (e.g., additional market analysts, etc.). In some examples, the public marketplace 722 includes an example insights banner 724, an example alert library 726, example popular reports 728, and/or an example search report 730.

At block 732, the second market analyst browses the public marketplace 722. For example, the second market analyst views the insights banner 724, the alert library 726, the popular reports 728, and/or the search report 730. At block 734, the second market analyst selects a report and/or alert. For example, Candace selects a report associated with the manufacturer and/or product of interest. At block 736, the example action determiner 114 filters reports (e.g., the insights banner 724, the alert library 726, the popular reports 728, and/or the search report 730) to generate an example preview report 738. In some examples, the preview report 738 includes fewer details with respect to the reports of the first user discovery phase 702 (e.g., the example insights banner 710, the example driving force report 712, the example grade report 714, and/or the example insight report 716). In some examples, the preview report 738 is an example report 740. For example, the report 740 is a report requiring contact information and/or validation.

The example user device 118 displays an example checkout page 742. For example, the checkout page 742 includes the preview report 738 and the cost of buying the preview report 738. Additionally or alternatively, the checkout page 742 includes related products (e.g., “You May Also Like,” “Frequently Bought Together,” etc.). At block 744, the second market analyst buys the report.

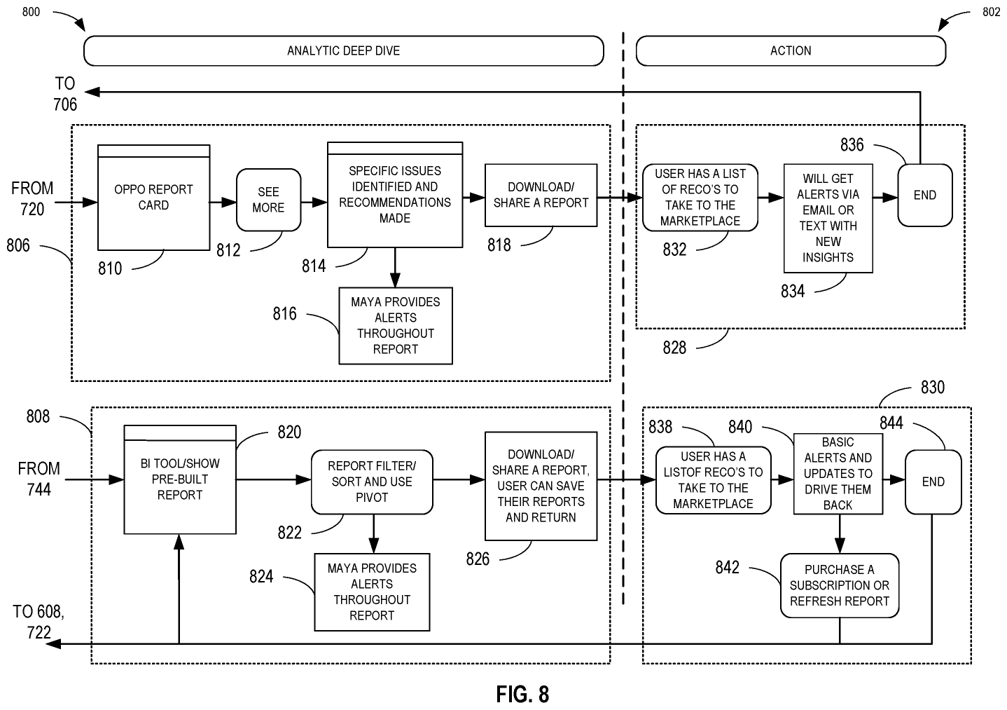

FIG. 8 includes an example analytics phase 800 and an example action phase 802. For example, during the analytics phase 800, a market analyst reviews reports generated by the example action determiner 114 (FIG. 1). Additionally or alternatively, during the example action phase 802, the market analyst takes an action in response to the report. In the illustrated example of FIG. 8, the analytics phase 800 includes an example first analytics phase 806 and an example second analytics phase 808. For example, the first analytics phase 806 corresponds to the first market analyst (e.g., Kelsey) and the second analytics phase 808 corresponds to the second market analyst (e.g., Candace).

The first analytics phase 806 begins with an example opportunity report card 810. For example, the user device 118 (FIG. 1) displays the opportunity report card 810 to the first market analyst. In some examples, the opportunity report card 810 corresponds to the selected opportunity (e.g., selected by the first market analyst at block 720 of FIG. 7). For example, the opportunity report card 810 corresponds to a product. At block 812, the market analyst indicates to further review the opportunity report card 810. For example, the market analyst can click a “See More” button. The user device 118 displays an example expanded opportunity report card 814. For example, the expanded opportunity report card 814 identifies specific issues and recommendations (e.g., levers associated with the opportunity). In some examples, the expanded opportunity report card 814 includes example alerts 816. For example, the alerts 816 include alerts related to the specific issues and recommendations (e.g., alerting the market analyst of a relatively low grade, etc.). At block 818, the first market analyst downloads the report. For example, the first market analyst saves the expanded opportunity report card 814 on memory of the user device 118, shares the expanded opportunity report card 814 (e.g., emails the report, etc.), etc.

The example second analytics phase 808 includes an example pre-built report 820. In some examples, the pre-built report 820 includes a BI tool. At block 822, the second market analyst reviews the example pre-built report 820. For example, the second market analyst can filter, sort, etc. the pre-built report 820 based on a product, a market, a lever, etc. In some examples, the market analyst's action at block 822 prompts an example alert 824. At block 826, the second market analyst downloads the pre-built report 820. For example, the second market analyst can save, download, share, etc. the pre-built report 820.

The example action phase 802 includes an example first action phase 828 and an example second action phase 830. The example first action phase 828 is associated with the first market analyst and the second action phase 830 is associated with the second market analyst. The example first action phase 828 begins at block 832, at which the first market analyst has received a list of recommendations to take to the marketplace. For example, the list of recommendations includes the expanded opportunity report card 814. At block 834, the first market analyst receives an alert. For example, the first market analyst receives an email, a text, etc. including the alert. In some examples, the alert includes new insights regarding the selected opportunity (e.g., a grade change of a lever, an amount to increase the price of a product, etc.). In some examples, the alert is in response to a user query, occurs on a periodic basis, etc. At block 836, the first action phase 828 ends. In some examples, the market strategy workflow of the first market analyst returns to the example first homepage 706 of FIG. 7.

The example second action phase 830 begins at block 838, at which the second market analyst has received a list of recommendations to take to the marketplace. At block 840, the second market analyst receives basic alerts. In some examples, the basic alert includes a notification of a grade change for a lever. At block 842, the second market analyst purchases a subscription and/or an additional report. For example, the second market analyst purchases a subscription to the robust version of the market strategy workflow (e.g., the market strategy workflow corresponding to the first market analyst). However, in some examples, the second market analyst does not purchase a subscription and/or an additional report. That is, at block 844, the second action phase 830 ends. In some examples, the market strategy workflow of the second market analyst returns to block 608 of FIG. 6 and/or the example public marketplace 722 of FIG. 7.

FIG. 9 illustrates an example alert 900 generated by the example system of FIG. 1 to identify an action for a marketing strategy. In examples disclosed herein, the output generator 232 (FIG. 2) generates the alert 900 periodically (e.g., once a month, etc.). In some examples, the alert 900 corresponds to the alert 816 and/or the alert 824 of FIG. 8. For example, the alert 900 includes an overview of opportunities a market analyst can act on. For example, the alert 900 includes a summary for Jose Cuervo (Proximo Spirits Inc) sales in Cocktails Ready to Drink including an indication that sales were up 6.3% compared to the previous four weeks. The alert 900 also includes an overview of growth, brand ranking, and market performance for Cocktails Ready to Drink. The alert 900 directs the market analyst to reports for additional details (e.g., the category and brand trend report, the brand ranking report, and/or the product performance report).

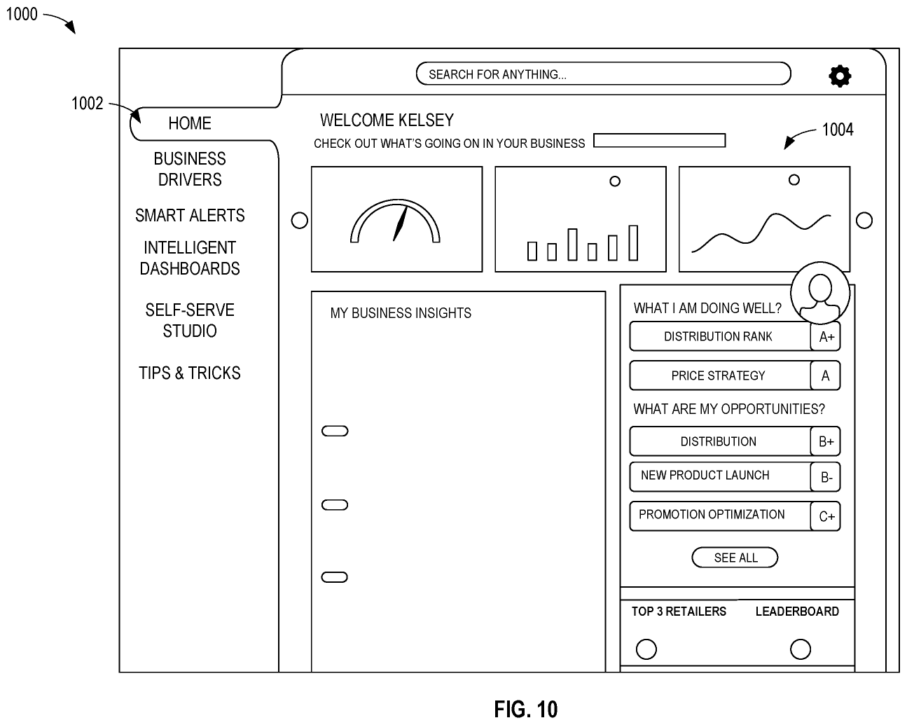

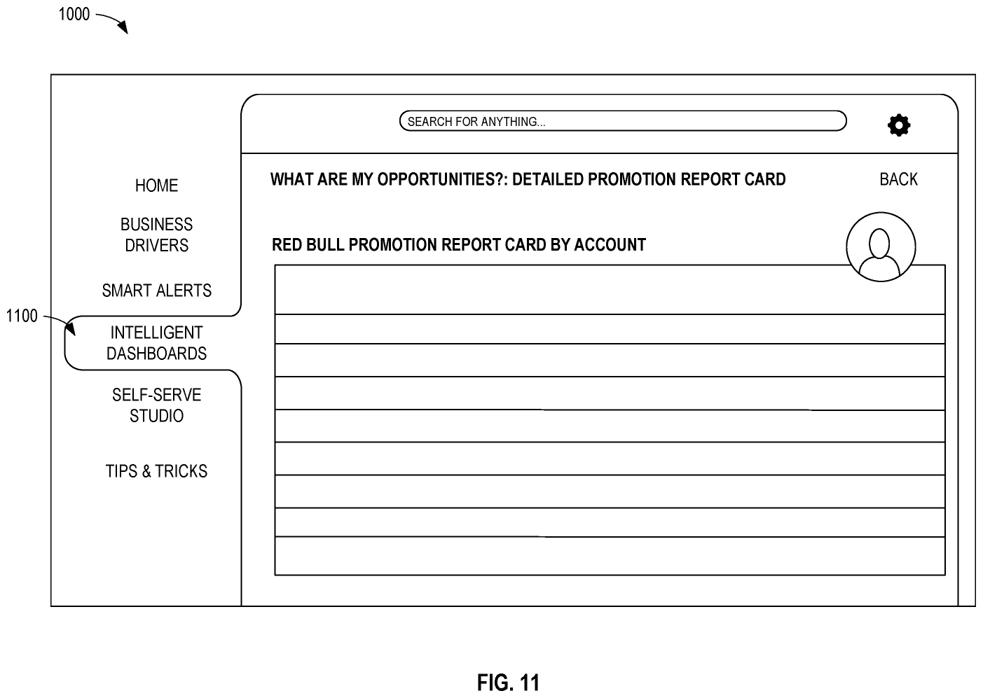

FIGS. 10-11 illustrate an example user interface 1000 to display an example homepage 1002. In some examples, the homepage 1002 corresponds to the first homepage 706 (FIG. 7) of the first market analyst (e.g., Kelsey). For example, the first market analyst receives the alert 900 (FIG. 9) and accesses the user interface 1000 to view a more detailed report. The example homepage 1002 includes an aggregated scorecard highlighting the biggest opportunity to improve sales at the macro level. That is, in some examples, the homepage 1002 displays the market, product, lever, etc. with the lowest grade. For example, the homepage 1002 can include example graphs 1004 summarizing market share, market growth, etc. The homepage 1002 can also include business insights and/or lever scores (e.g., the distribution rank score is A+, the price strategy score is A, etc.).

FIG. 11 illustrates the example user interface 1000 to display an example intelligent dashboard 1100. In the illustrated example of FIG. 11, the intelligent dashboard 1100 corresponds to the Promotion lever. The intelligent dashboard 1100 illustrates additional details corresponding to the Promotion lever. For example, the intelligent dashboard 1100 illustrates a product report card for multiple accounts. This allows the market analyst to identify which accounts to focus on (e.g., accounts with relatively lower scores). For example, the intelligent dashboard 1100 can include a “Whole Foods Total CTA” account with a score of a “B+” and a “Publix Total” account with a score of a “C” (not illustrated).

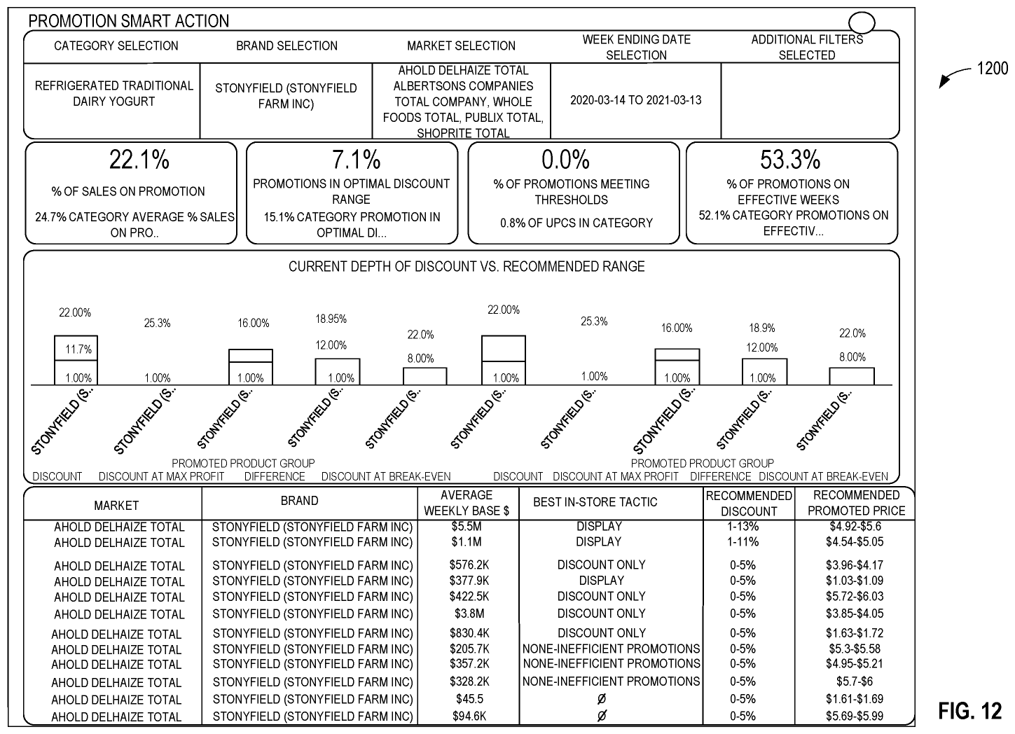

FIG. 12 illustrates an example smart action 1200. For example, the smart action 1200 displays recommendations to the market analyst. For example, the intelligent dashboard 1100 of FIG. 11 displays an overview of scores for a product for multiple accounts. The market analyst may select an account with a relatively lower score to focus on. In the illustrated example, the relatively lower scores for the accounts were due to the depth of discount sub-lever. For example, the smart action 1200 indicates 7.1% of the brand selection (e.g., Stonyfield (Stonyfield Farm Inc)) had promotions in the target discount range, 0.0% of the brand selection met the promotions threshold, etc. The smart action 1200 provides the market analyst with a specific recommendation on the price point that should be met for promotions to drive results with shoppers (e.g., conversions, purchases, etc.). That is, previous techniques indicated a market analyst should increase or decrease the promotion price. In contrast, examples disclosed herein recommend a value to increase or decrease the promotion price to.

FIG. 13 illustrates example net profit data 1300 used by the example system of FIG. 1 to identify an action for a marketing strategy. In some examples, the pricing determiner 208 (FIG. 2) generates the net profit data 1300. For example, the pricing determiner 208 determines the target principle for the optimal price gaps sub-lever based on the net profit data 1300. For example, the pricing determiner 208 determines the net profit data 1300 for a pair of items (e.g., a pair of internal competitor items, a pair of external competitor items) using Monte Carlo simulations based on the a 5^{th} to 95^{th} percentile price gap between the pair of items. The pricing determiner 208 determines the optimal price gap by identifying an example profit maximizing point 1302.

FIG. 14 illustrates an example decision framework 1400. For example, the pricing determiner 208 (FIG. 2) determines the target principle recommended price strategy for the recommended price strategy sub-lever based on the decision framework 1400. In the illustrated example of FIG. 14, the decision framework 1400 is based on everyday price elasticity (e.g., base price elasticity) and promoted price elasticity (e.g., promotional price elasticity/intensity). In the illustrated example of FIG. 14, the decision framework 1400 includes four pricing strategies: an EDLP pricing strategy (e.g., divert trade investments away from promotions to maintain low base price on an everyday basis), an options pricing strategy (e.g., leverage both base and promotion depending on objectives and retailer's category strategy), a high-shallow pricing strategy (e.g., reduce depth of promotional discounts and/or increase everyday price to recapture margin and drive additional gross profit (GP)), and a high-low pricing strategy (e.g., invest in promotion to drive volume and protect share by increasing base price to fund additional promotion depth and/or frequency). For example, if the pricing determiner 208 determines a high everyday price elasticity and a low promoted price elasticity, the pricing determiner 208 selects the EDLP pricing strategy.

While an example manner of implementing the action determiner 114 of FIG. 1 is illustrated in FIG. 2, one or more of the elements, processes and/or devices illustrated in FIG. 2 may be combined, divided, re-arranged, omitted, eliminated and/or implemented in any other way. Further, the example data accessor 202, the example data lake 204, the example model trainer 205, the example target principle generator 206, the example pricing determiner 208, the example promotion determiner 210, the example assortment determiner 212, the example new product determiner 214, the example in-store execution determiner 216, the example execution analyzer 218, the example pricing analyzer 220, the example promotion analyzer 222, the example assortment analyzer 224, the example new product analyzer 226, the example execution analyzer 228, the example score generator 230, the example output generator 232, and/or, more generally, the example action determiner 114 of FIG. 2 may be implemented by hardware, software, firmware and/or any combination of hardware, software and/or firmware. Thus, for example, any of the example data accessor 202, the example data lake 204, the example model trainer 205, the example target principle generator 206, the example pricing determiner 208, the example promotion determiner 210, the example assortment determiner 212, the example new product determiner 214, the example in-store execution determiner 216, the example execution analyzer 218, the example pricing analyzer 220, the example promotion analyzer 222, the example assortment analyzer 224, the example new product analyzer 226, the example execution analyzer 228, the example score generator 230, the example output generator 232 and/or, more generally, the example action determiner 114 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example, data accessor 202, the example data lake 204, the example model trainer 205, the example target principle generator 206, the example pricing determiner 208, the example promotion determiner 210, the example assortment determiner 212, the example new product determiner 214, the example in-store execution determiner 216, the example execution analyzer 218, the example pricing analyzer 220, the example promotion analyzer 222, the example assortment analyzer 224, the example new product analyzer 226, the example execution analyzer 228, the example score generator 230, and/or the example output generator 232 is/are hereby expressly defined to include a non-transitory computer readable storage device or storage disk such as a memory, a digital versatile disk (DVD), a compact disk (CD), a Blu-ray disk, etc. including the software and/or firmware. Further still, the example action determiner 114 of FIG. 1 may include one or more elements, processes and/or devices in addition to, or instead of, those illustrated in FIG. 3, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

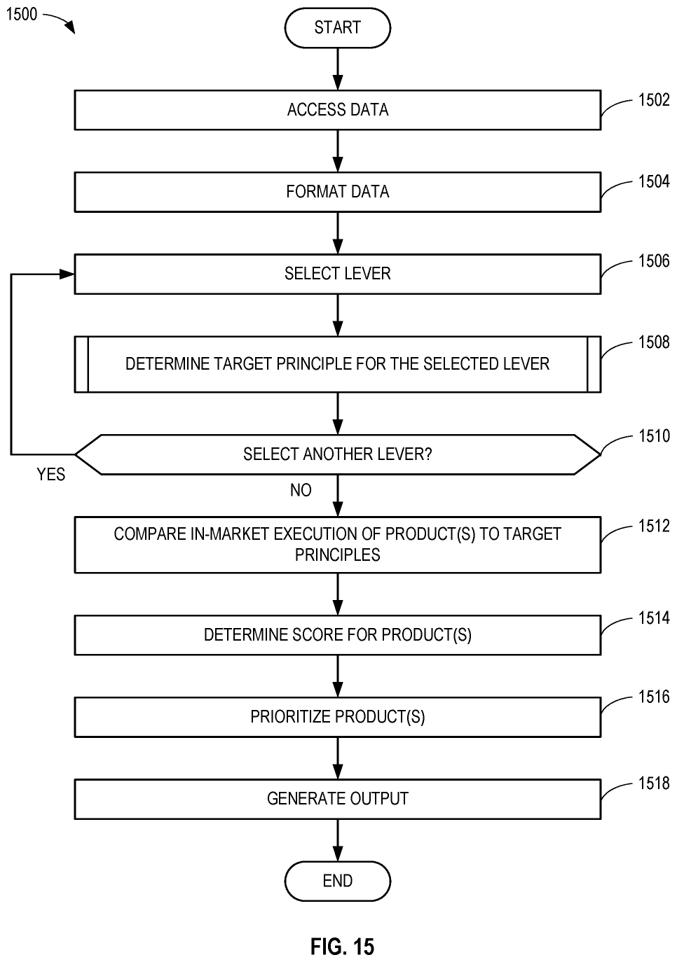

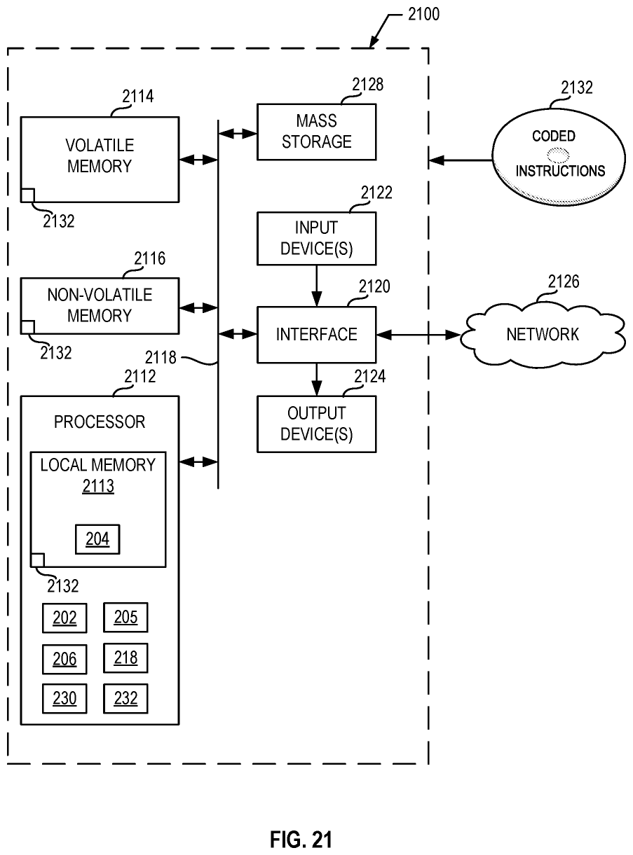

Flowcharts representative of example hardware logic, machine readable instructions, hardware implemented state machines, and/or any combination thereof for implementing the action determiner 114 of FIG. 2 are shown in FIGS. 15-20. The machine readable instructions may be one or more executable programs or portion(s) of an executable program for execution by a computer processor and/or processor circuitry, such as the processor 2112 shown in the example processor platform 2100 discussed below in connection with FIG. 21. The program may be embodied in software stored on a non-transitory computer readable storage medium such as a CD-ROM, a floppy disk, a hard drive, a DVD, a Blu-ray disk, or a memory associated with the processor 2112, but the entire program and/or parts thereof could alternatively be executed by a device other than the processor 2112 and/or embodied in firmware or dedicated hardware. Further, although the example program is described with reference to the flowcharts illustrated in FIGS. 15-20, many other methods of implementing the example action determiner 114 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement one or more functions that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example processes of FIGS. 15-20 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 15 is a flowchart 1500 representative of example machine-readable instructions that may be executed to implement the action determiner 114 of FIGS. 1 and/or 2. The example machine-readable instructions of FIG. 15 begin at block 1502 at which the data accessor 202 (FIG. 2) accesses the data stored in the client databases 102, 104, 106, 108. In some examples, the client databases 102, 104, 106, 108 includes UPC data, panel data, POS data, location data, etc. The example data accessor 202 formats the data (block 1504). For example, the data accessor 202 deduplicates the data accessed from the client databases 102, 104, 106, 108. In some examples, the data accessor 202 stores the formatted data in the example data lake 204 (FIG. 2).

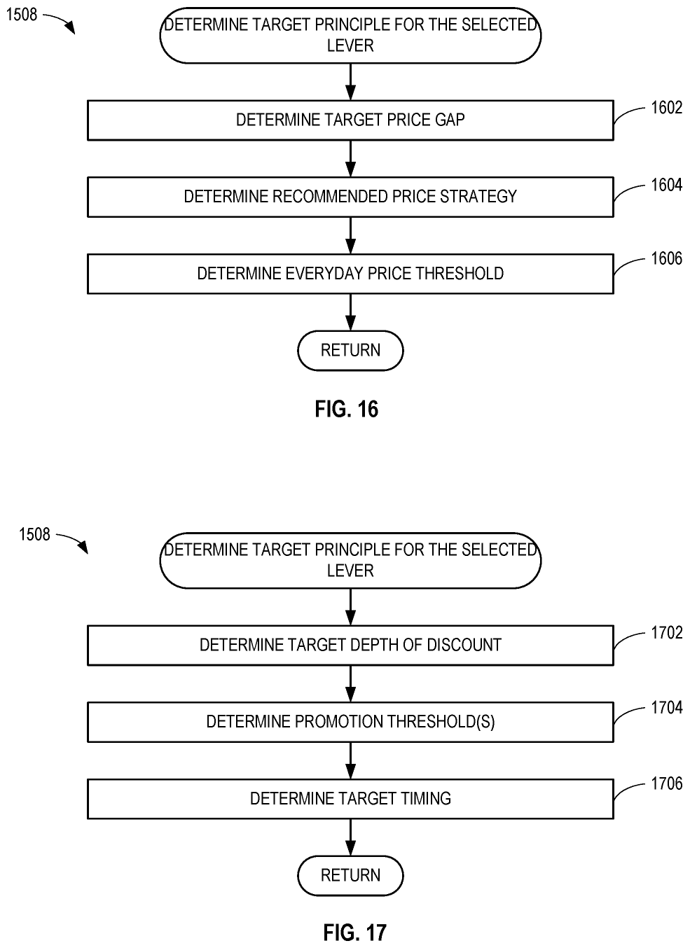

The example target principle generator 206 (FIG. 2) selects a lever (block 1506). In some examples, the levers include a price lever, a promotion lever, an assortment lever, a new products lever, and an execution lever. In some examples, the target principle generator 206 selects a lever based on user input (e.g., a market analyst selects the pricing lever to analyze). The target principle generator 206 determines target principles for the selected lever (block 1508). For example, the target principle generator 206 determines a price target principle based on optimal price gaps, recommended price strategy, and/or everyday price thresholds. The target principle generator 206 determines a promotion target principle based on optimal depth of discount, promoted thresholds, and/or promotion timing. Additionally or alternatively, the target principle generator 206 determines an assortment target principle, a new product target principle and/or an execution target principle. Further example instructions that may be used to implement block 1508 are described below in connection with FIGS. 16-20.

The target principle generator 206 determines whether to select another lever (block 1510). For example, the target principle generator 206 determines whether there are levers that have not been analyzed. If, at block 1510, the target principle generator 206 determines to select another lever, instructions return to block 1506. If, at block 1510, the target principle generator 206 determines to not select another lever, the example execution analyzer 218 (FIG. 2) compares in-market execution of product(s) to target principles (block 1512). For example, the execution analyzer 218 compares in-market data to the target principles determined at block 1508 to identify marketing opportunities. The execution analyzer 218 can compare in-market everyday prices relative to the target gaps, internal and external competitors, compliance to price thresholds, etc. In some examples, the execution analyzer 218 identifies instances in which the in-market strategies and executions differ from the target principles.

The example score generator 230 (FIG. 2) determines a score for one or more product(s) (block 1514). For example, the score generator 230 determines aggregate scores for one or more levers of a product and/or market. In some examples, the score generator 230 assigns a numerical score, a letter score, etc. The example score generator 230 prioritizes the one or more product(s) based on the product score (block 1516). For example, the score generator 230 can arrange the products based on opportunity (e.g., the lowest scored product to the highest scored product). That is, the score generator 230 identifies and prioritizes products a market analyst should focus on based on the product score.

The example output generator 232 (FIG. 2) generates an output (block 1518). For example, the output generator 232 generates an alert, a report card, etc. including the product scores determined at block 1516. In some examples, output generator 232 generates the report 116 of FIG. 1, which includes a recommended action for a market analyst to perform (e.g., adjust product price, remove product from retailer, etc.). For example, the user device 118 (FIG. 1) obtains and displays the report 116.

FIG. 16 is a flowchart 1508 representative of example machine-readable instructions that may be executed to implement the example pricing determiner 208 of FIG. 2 to determine a target principle for the price lever. The example machine-readable instructions of FIG. 16 begin at block 1602, at which the example pricing determiner 208 determines a target price gap. For example, the pricing determiner 208 determines the target principle for the target price gap sub-lever. For example, the pricing determiner 208 determines the target price gap using a Monte Carlo simulation to calculate the net profit for pairs of products.

The example pricing determiner 208 determines a recommended price strategy (block 1604). For example, the pricing determiner 208 determines the recommended price strategy for the recommended price strategy sub-lever. In some examples, the pricing determiner 208 determines the recommended price strategy based on the decision framework 1400 of FIG. 4. For example, if the pricing determiner 208 determines the everyday price elasticity is low and the promoted price elasticity is high, the pricing determiner 208 identifies the high-low pricing strategy as the recommended price strategy.

The example pricing determiner 208 determines an everyday price threshold (block 1606). For example, the pricing determiner 208 determines everyday price thresholds using a multiplicative multiple regression model. For example, the pricing determiner 208 determines the everyday price threshold in a manner consistent with example Equation 1. Instructions return to block 1510 of FIG. 15.

FIG. 17 is a flowchart 1508 representative of example machine-readable instructions that may be executed to implement the example promotion determiner 210 of FIG. 2 to determine a target principle for the promotion lever. The example machine-readable instructions of FIG. 17 begin at block 1702, at which the example promotion determiner 210 determines a target depth of discount. For example, the promotion determiner 210 determines the target depth of discount based on example code illustrated in Table 1 and Table 2.

The example promotion determiner 210 determines one or more promotion threshold(s) (block 1704). For example, the promotion determiner 210 determines promotion thresholds using a multiplicative multiple regression model. That is, the promotion determiner 210 determines promotion thresholds in a manner consistent with example Equation 2. The example promotion determiner 210 determines target timing (block 1706). For example, the promotion determiner 210 determines the target timing of a promotion based on example code illustrated in Table 3. Instructions return to block 1510 of FIG. 15.

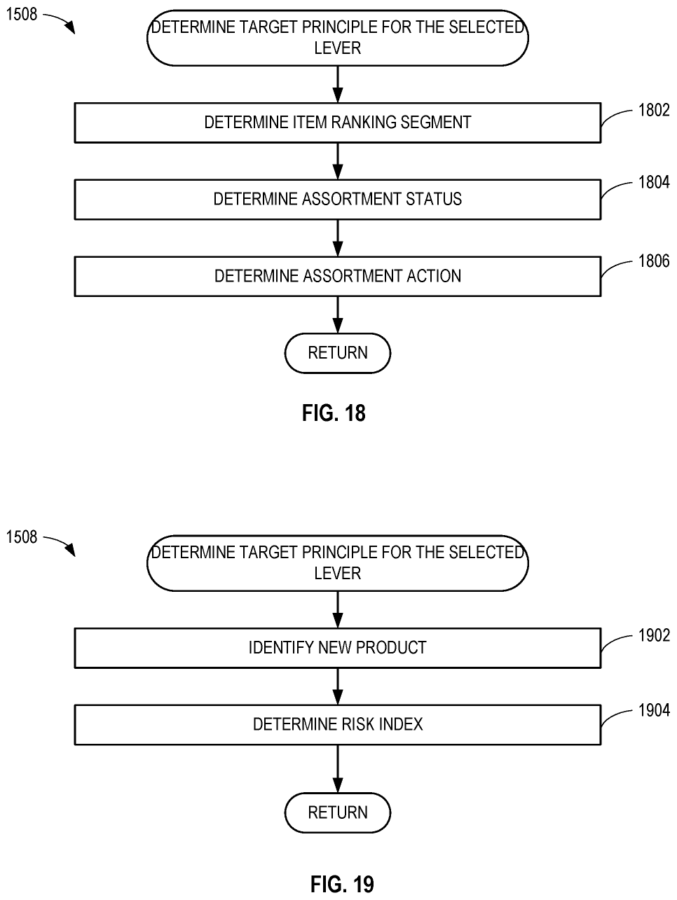

FIG. 18 is a flowchart 1508 representative of example machine-readable instructions that may be executed to implement the example assortment determiner 212 of FIG. 2 to determine a target principle for the assortment lever. The example machine-readable instructions of FIG. 18 begin at block 1802, at which the example assortment determiner 212 determines an item ranking segment. For example, the assortment determiner 212 determines the item ranking segment based on code illustrated in Tables 4-6. For example, the assortment determiner 212 determines the item ranking segment based on item z-scores and item ranks. In some examples, the item ranking segments include labels “Best-in-Class”, “Core”, “At Risk”, and “Bottom 20%”.

The example assortment determiner 212 determines an assortment status (block 1804). For example, the assortment determiner 212 determines the assortment status based on example code in Table 7. In some examples, the assortment status includes labels “New”, “High Distribution”, “Core”, “Delisted”, “Not Carried” and “Existed”. The example assortment determiner 212 determines an assortment action (block 1806). For example, the assortment determiner 212 determines the assortment action based on the item ranking segment and the assortment status. The example assortment determiner 212 determines the assortment action based on example code illustrated in Table 8. In some examples, the assortment actions include labels “Maintain”, “At Risk”, “Add”, and “Expand”. Instructions return to block 1510 of FIG. 15.

FIG. 19 is a flowchart 1508 representative of example machine-readable instructions that may be executed to implement the example new product determiner 214 of FIG. 2 to determine a target principle for the new product lever. The example machine-readable instructions of FIG. 19 begin at block 1902, at which the new product determiner 214 identifies a new item. For example, the new product determiner 214 identifies an item by scanning the data lake 204 (FIG. 2) to identify items that had a first sale in the last 52 weeks.

The example new product determiner 214 determines a risk index of the new product (block 1904). For example, the new product determiner 214 determines the risk index based on example code illustrated in Table 9. In some examples, the new product determiner 214 determines the risk index based on a risk score. For example, the risk score is based on a velocity score, a dollar score, and a TDP score of the new product. In some examples, the new product determiner 214 ranks the new products in ascending order such that a low performance indicates a high risk of delisting. Instructions return to block 1510 of FIG. 15.

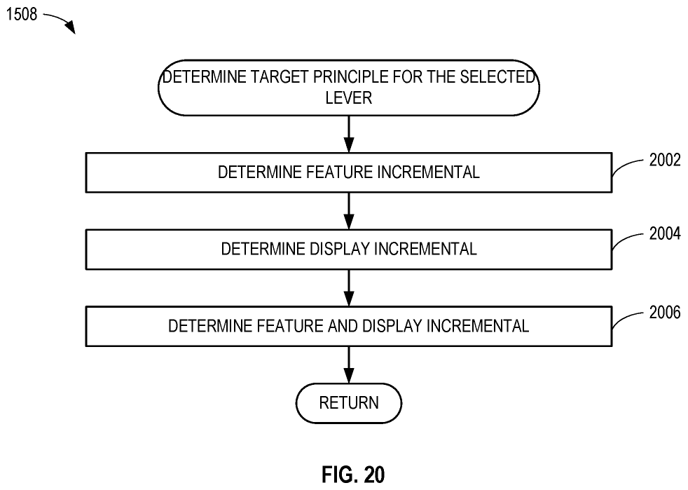

FIG. 20 is a flowchart 1508 representative of example machine-readable instructions that may be executed to implement the example execution determiner 216 of FIG. 2 to determine a target principle for the execution lever. The example machine-readable instructions of FIG. 20 begin at block 2002, at which the execution determiner 216 determines a feature incremental. The example execution determiner 216 determines a display incremental (block 2004). The example execution determiner 216 determines a feature and display incremental (block 2006). In examples disclosed herein, the execution determiner 216 determines the feature incremental, display incremental, and feature and display incremental based on example code illustrated in Table 10. In some examples, the execution determiner 216 ranks the incremental(s) across PPGs to determine the value of the product on promotion. Instructions return to block 1510 of FIG. 15.

FIG. 21 is a block diagram of an example processor platform 2100 structured to execute the instructions of FIGS. 15-20 to implement the action determiner 114 of FIGS. 1 and/or 2. The processor platform 2100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 2100 of the illustrated example includes a processor 2112. The processor 2112 of the illustrated example is hardware. For example, the processor 2112 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements data accessor 202, the example data lake 204, the example model trainer 205, the example target principle generator 206, the example pricing determiner 208, the example promotion determiner 210, the example assortment determiner 212, the example new product determiner 214, the example in-store execution determiner 216, the example execution analyzer 218, the example pricing analyzer 220, the example promotion analyzer 222, the example assortment analyzer 224, the example new product analyzer 226, the example execution analyzer 228, the example score generator 230, and/or the example output generator 232.

The processor 2112 of the illustrated example includes a local memory 2113 (e.g., a cache). The processor 2112 of the illustrated example is in communication with a main memory including a volatile memory 2114 and a non-volatile memory 2116 via a bus 2118. The volatile memory 2114 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 2116 may be implemented by flash memory and/or any other desired type of memory device. Access to the main memory 2114, 2116 is controlled by a memory controller.

The processor platform 2100 of the illustrated example also includes an interface circuit 2120. The interface circuit 2120 may be implemented by any type of interface standard, such as an Ethernet interface, a universal serial bus (USB), a Bluetooth® interface, a near field communication (NFC) interface, and/or a PCI express interface.

In the illustrated example, one or more input devices 2122 are connected to the interface circuit 2120. The input device(s) 2122 permit(s) a user to enter data and/or commands into the processor 2112. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 2124 are also connected to the interface circuit 2120 of the illustrated example. The output devices 2124 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 2120 of the illustrated example, thus, typically includes a graphics driver card, a graphics driver chip and/or a graphics driver processor.

The interface circuit 2120 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 2126. The communication can be via, for example, an Ethernet connection, a digital subscriber line (DSL) connection, a telephone line connection, a coaxial cable system, a satellite system, a line-of-site wireless system, a cellular telephone system, etc.

The processor platform 2100 of the illustrated example also includes one or more mass storage devices 2128 for storing software and/or data. Examples of such mass storage devices 2128 include floppy disk drives, hard drive disks, compact disk drives, Blu-ray disk drives, redundant array of independent disks (RAID) systems, and digital versatile disk (DVD) drives.

The machine executable instructions 2132 of FIGS. 15-20 may be stored in the mass storage device 2128, in the volatile memory 2114, in the non-volatile memory 2116, and/or on a removable non-transitory computer readable storage medium such as a CD or DVD.

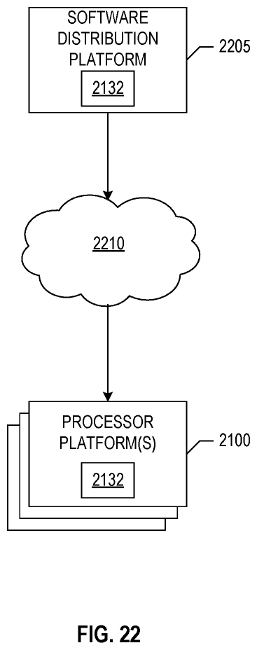

A block diagram illustrating an example software distribution platform 2205 to distribute software such as the example computer readable instructions 2132 of FIG. 21 to third parties is illustrated in FIG. 22. The example software distribution platform 2205 may be implemented by any computer server, data facility, cloud service, etc., capable of storing and transmitting software to other computing devices. The third parties may be customers of the entity owning and/or operating the software distribution platform. For example, the entity that owns and/or operates the software distribution platform may be a developer, a seller, and/or a licensor of software such as the example computer readable instructions 2132 of FIG. 21. The third parties may be consumers, users, retailers, OEMs, etc., who purchase and/or license the software for use and/or re-sale and/or sub-licensing. In the illustrated example, the software distribution platform 2205 includes one or more servers and one or more storage devices. The storage devices store the computer readable instructions 2132, which may correspond to the example computer readable instructions 2132 of FIGS. 15-20, as described above. The one or more servers of the example software distribution platform 2205 are in communication with a network 2210, which may correspond to any one or more of the Internet and/or any of the example networks 2126 described above. In some examples, the one or more servers are responsive to requests to transmit the software to a requesting party as part of a commercial transaction. Payment for the delivery, sale and/or license of the software may be handled by the one or more servers of the software distribution platform and/or via a third party payment entity. The servers enable purchasers and/or licensors to download the computer readable instructions 2132 from the software distribution platform 2205. For example, the software, which may correspond to the example computer readable instructions 2132 of FIG. 21, may be downloaded to the example processor platform 2100, which is to execute the computer readable instructions 2132 to implement the example action determiner 114 of FIGS. 1 and/or 2. In some example, one or more servers of the software distribution platform 2205 periodically offer, transmit, and/or force updates to the software (e.g., the example computer readable instructions 2132 of FIG. 21) to ensure improvements, patches, updates, etc. are distributed and applied to the software at the end user devices.

From the foregoing, it will be appreciated that example methods, apparatus and articles of manufacture have been disclosed that identify market strategies based on in-market data and target market principles. Disclosed methods, apparatus and articles of manufacture improve the efficiency of using a computing device by autonomously analyzing in-market data to provide fast and actionable market actions. Disclosed methods, apparatus and articles of manufacture also reduce discretionary input of market analysts. Disclosed methods, apparatus and articles of manufacture are accordingly directed to one or more improvement(s) in the functioning of a computer.

Example methods, apparatus, systems, and articles of manufacture to adjust market strategies are disclosed herein. Further examples and combinations thereof include the following:

Example 1 includes an apparatus to control market strategy adjustments, the apparatus comprising a target principle generator to determine a target principle of a product based on at least one lever, the at least one lever indicative of an adjustable parameter corresponding to the product, an execution analyzer to compare in-market data of the product to the target principle of the product, a score generator to determine an aggregate score of the product based on the comparison, and an output generator to reduce discretionary input of an analyst by generating an output, the output including the aggregate score of the product and a recommended adjustment to the at least one lever.

Example 2 includes the apparatus as defined in example 1, wherein the output is at least one of an alert, a report card, or a dashboard.

Example 3 includes the apparatus as defined in example 1, wherein the at least one lever corresponds to a pricing parameter, and the target principle generator is to determine the target principle of the product based on an internal price gap, an external price gap, and an everyday price threshold.

Example 4 includes the apparatus as defined in example 1, wherein the at least one lever corresponds to a promotion parameter, and the target principle generator is to determine the target principle of the product based on a depth of discount, a promotion frequency, a timing of an event, a promoted price threshold, and an offer communication.

Example 5 includes the apparatus as defined in example 1, wherein the at least one lever corresponds to an assortment parameter, the product is a first product, and the target principle generator is to determine to remove the first product or add a second product.

Example 6 includes the apparatus as defined in example 1, wherein the at least one lever corresponds to a new products parameter, and the target principle generator is to determine a hurdle rate for the product.

Example 7 includes the apparatus as defined in example 1, wherein the at least one lever corresponds to an execution parameter, and the target principle generator is to determine an incremental value of the product based on a location of the product in a store.

Example 8 includes the apparatus as defined in example 1, wherein the product is a first product and the aggregate score is a first aggregate score, and the score generator is to determine a second aggregate score for a second product.

Example 9 includes the apparatus as defined in example 8, wherein the output generator is to generate the output including the first product and the second product based on the first aggregate score and the second aggregate score.

Example 10 includes the apparatus as defined in example 9, wherein the output generator is to display the first product before the second product in response to the first aggregate score being lower than the second aggregate score.

Example 11 includes a non-transitory computer readable medium comprising instructions that, when executed, cause at least one processor to, at least determine a target principle of a product based on at least one lever, the at least one lever indicative of an adjustable parameter corresponding to the product, compare in-market data of the product to the target principle of the product, determine an aggregate score of the product based on the comparison, and reduce discretionary input of an analyst by generating an output, the output including the aggregate score of the product and a recommended adjustment to the at least one lever.

Example 12 includes the non-transitory computer readable medium as defined in example 11, wherein the output is at least one of an alert, a report card, or a dashboard.

Example 13 includes the non-transitory computer readable medium as defined in example 11, wherein the at least one lever corresponds to a pricing parameter, and the instructions, when executed, further cause the at least one processor to determine the target principle of the product based on an internal price gap, an external price gap, and an everyday price threshold.

Example 14 includes the non-transitory computer readable medium as defined in example 11, wherein the at least one lever corresponds to a promotion parameter, and the instructions, when executed, further cause the at least one processor to determine the target principle of the product based on a depth of discount, a promotion frequency, a timing of an event, a promoted price threshold, and an offer communication.

Example 15 includes the non-transitory computer readable medium as defined in example 11, wherein the at least one lever corresponds to an assortment parameter, the product is a first product, and the instructions, when executed, further cause the at least one processor to determine to remove the first product or add a second product.

Example 16 includes the non-transitory computer readable medium as defined in example 11, wherein the at least one lever corresponds to a new products parameter, and the instructions, when executed, further cause the at least one processor to determine a hurdle rate for the product.

Example 17 includes the non-transitory computer readable medium as defined in example 11, wherein the at least one lever corresponds to an execution parameter, and the instructions, when executed, further cause the at least one processor to determine an incremental value of the product based on a location of the product in a store.

Example 18 includes the non-transitory computer readable medium as defined in example 11, wherein the product is a first product and the aggregate score is a first aggregate score, and the instructions, when executed, further cause the at least one processor to determine a second aggregate score for a second product.

Example 19 includes the non-transitory computer readable medium as defined in example 18, wherein the instructions, when executed, further cause the at least one processor to generate the output including the first product and the second product based on the first aggregate score and the second aggregate score.

Example 20 includes the non-transitory computer readable medium as defined in example 19, wherein the instructions, when executed, further cause the at least one processor to display the first product before the second product in response to the first aggregate score being lower than the second aggregate score.

Example 21 includes an apparatus to control market strategy adjustments, the apparatus comprising at least one storage device, and a processor circuitry to determine a target principle of a product based on at least one lever, the at least one lever indicative of an adjustable parameter corresponding to the product, compare in-market data of the product to the target principle of the product, determine an aggregate score of the product based on the comparison, and reduce discretionary input of an analyst by generating an output, the output including the aggregate score of the product and a recommended adjustment to the at least one lever.

Example 22 includes the apparatus as defined in example 21, wherein the output is at least one of an alert, a report card, or a dashboard.

Example 23 includes the apparatus as defined in example 21, wherein the at least one lever corresponds to a pricing parameter, and the processor circuitry is to determine the target principle of the product based on an internal price gap, an external price gap, and an everyday price threshold.

Example 24 includes the apparatus as defined in example 21, wherein the at least one lever corresponds to a promotion parameter, and the processor circuitry is to determine the target principle of the product based on a depth of discount, a promotion frequency, a timing of an event, a promoted price threshold, and an offer communication.

Example 25 includes the apparatus as defined in example 21, wherein the at least one lever corresponds to an assortment parameter, the product is a first product, and the processor circuitry is to determine to remove the first product or add a second product.

Example 26 includes the apparatus as defined in example 21, wherein the at least one lever corresponds to a new products parameter, and the processor circuitry is to determine a hurdle rate for the product.

Example 27 includes the apparatus as defined in example 21, wherein the at least one lever corresponds to an execution parameter, and the processor circuitry is to determine an incremental value of the product based on a location of the product in a store.

Example 28 includes the apparatus as defined in example 21, wherein the product is a first product and the aggregate score is a first aggregate score, and the processor circuitry is to determine a second aggregate score for a second product.

Example 29 includes the apparatus as defined in example 28, wherein the processor circuitry is to generate the output including the first product and the second product based on the first aggregate score and the second aggregate score.

Example 30 includes the apparatus as defined in example 29, wherein the processor circuitry is to display the first product before the second product in response to the first aggregate score being lower than the second aggregate score.

Example 31 includes an apparatus to control market strategy adjustments, the apparatus comprising means for determining a target principle to determine the target principle of a product based on at least one lever, the at least one lever indicative of an adjustable parameter corresponding to the product, means for comparing data to compare in-market data of the product to the target principle of the product, means for generating a score to determine an aggregate score of the product based on the comparison, and means for generating an output to reduce discretionary input of an analyst by generating the output, the output including the aggregate score of the product and a recommended adjustment to the at least one lever.

Example 32 includes the apparatus as defined in example 31, wherein the output is at least one of an alert, a report card, or a dashboard.

Example 33 includes the apparatus as defined in example 31, wherein the at least one lever corresponds to a pricing parameter, and the target principle determining means is to determine the target principle of the product based on an internal price gap, an external price gap, and an everyday price threshold.

Example 34 includes the apparatus as defined in example 31, wherein the at least one lever corresponds to a promotion parameter, and the target principle determining means is to determine the target principle of the product based on a depth of discount, a promotion frequency, a timing of an event, a promoted price threshold, and an offer communication.

Example 35 includes the apparatus as defined in example 31, wherein the at least one lever corresponds to an assortment parameter, the product is a first product, and the target principle determining means is to determine to remove the first product or add a second product.

Example 36 includes the apparatus as defined in example 31, wherein the at least one lever corresponds to a new products parameter, and the target principle determining means is to determine a hurdle rate for the product.

Example 37 includes the apparatus as defined in example 31, wherein the at least one lever corresponds to an execution parameter, and the target principle determining means is to determine an incremental value of the product based on a location of the product in a store.

Example 38 includes the apparatus as defined in example 31, wherein the product is a first product and the aggregate score is a first aggregate score, and score determining means is to determine a second aggregate score for a second product.

Example 39 includes the apparatus as defined in example 38, wherein the output generating means is to generate the output including the first product and the second product based on the first aggregate score and the second aggregate score.

Example 40 includes the apparatus as defined in example 39, wherein the output generating means is to display the first product before the second product in response to the first aggregate score being lower than the second aggregate score.

Example 41 includes a method to control market strategy adjustments, the method comprising determining a target principle of a product based on at least one lever, the at least one lever indicative of an adjustable parameter corresponding to the product, comparing in-market data of the product to the target principle of the product, determining an aggregate score of the product based on the comparison, and reducing discretionary input of an analyst by generating an output, the output including the aggregate score of the product and a recommended adjustment to the at least one lever.

Example 42 includes the method as defined in example 41, wherein the output is at least one of an alert, a report card, or a dashboard.

Example 43 includes the method as defined in example 41, wherein the at least one lever corresponds to a pricing parameter, and further including determining the target principle of the product based on an internal price gap, an external price gap, and an everyday price threshold.

Example 44 includes the method as defined in example 41, wherein the at least one lever corresponds to a promotion parameter, and further including determining the target principle of the product based on a depth of discount, a promotion frequency, a timing of an event, a promoted price threshold, and an offer communication.

Example 45 includes the method as defined in example 41, wherein the at least one lever corresponds to an assortment parameter, the product is a first product, and further including determining to remove the first product or add a second product.

Example 46 includes the method as defined in example 41, wherein the at least one lever corresponds to a new products parameter, and further including determining a hurdle rate for the product.

Example 47 includes the method as defined in example 41, wherein the at least one lever corresponds to an execution parameter, and further including determining an incremental value of the product based on a location of the product in a store.

Example 48 includes the method as defined in example 41, wherein the product is a first product and the aggregate score is a first aggregate score, and further including determining a second aggregate score for a second product.

Example 49 includes the method as defined in example 48, further including generating the output including the first product and the second product based on the first aggregate score and the second aggregate score.

Example 50 includes the method as defined in example 49, further including displaying the first product before the second product in response to the first aggregate score being lower than the second aggregate score.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

1.-50. (canceled)

51. An apparatus to distribute a product comprising:
interface circuitry;
machine-readable instructions; and
at least one processor circuit to be programmed by the machine-readable instructions to:
determine a sales velocity score associated with the product, the sales velocity score based on sales data from networked databases;
determine a price score associated with the product, the price score based on price data from the networked databases;
determine a distribution score associated with the product, the distribution score based on distribution data from the networked databases; and
cause the product to be one of (a) eliminated from a physical location or (b) added to the physical location based on an aggregate score of the sales velocity score, the price score and the distribution score.

52. The apparatus as defined in claim 51, wherein one or more of the at least one processor circuit is to determine a risk score of the product based on a weighted sum of the velocity score, the price score and the distribution score.

53. The apparatus as defined in claim 52, wherein one or more of the at least one processor circuit is to determine a risk index based on a ratio of the risk score and an average risk score associated with a category of the product.

54. The apparatus as defined in claim 52, wherein one or more of the at least one processor circuit is to eliminate the product from the physical location when the risk score does not satisfy a distribution threshold.

55. The apparatus as defined in claim 51, wherein one or more of the at least one processor circuit is to select a first lever of a plurality of levers, the plurality of levers indicative of adjustable parameters corresponding to the product.

56. The apparatus as defined in claim 55, wherein one or more of the at least one processor circuit is to determine target principles of the product, respective ones of the target principles based on (a) the first lever and (b) corresponding performance metrics associated with at least one of the sales data, the price data, or the distribution data.

57. The apparatus as defined in claim 56, wherein one or more of the at least one processor circuit is to:
generate scores for the target principles; and
transform the scores with binary status indicators.

58. The apparatus as defined in claim 55, wherein the first lever corresponds to a pricing parameter, wherein one or more of the at least one processor circuit is to determine target principles of the product based on an internal price gap, an external price gap, and an everyday price threshold.

59. The apparatus as defined in claim 55, wherein the first lever corresponds to a promotion parameter, wherein one or more of the at least one processor circuit is to determine target principles of the product based on a depth of discount, a promotion frequency, a timing of an event, and a promoted price threshold.

60. The apparatus as defined in claim 55, wherein the first lever corresponds to an assortment parameter, the product is a first product, wherein one or more of the at least one processor circuit is to remove the first product or add a second product based on the assortment parameter.

61. At least one non-transitory machine-readable medium comprising machine-readable instructions to cause at least one processor circuit to at least:
determine a sales velocity score associated with the product, the sales velocity score based on sales data from networked databases;
determine a price score associated with the product, the price score based on price data from the networked databases;
determine a distribution score associated with the product, the distribution score based on distribution data from the networked databases; and
cause the product to be one of (a) eliminated from a physical location or (b) added to the physical location based on an aggregate score of the sales velocity score, the price score and the distribution score.

62. The at least one non-transitory machine-readable medium as defined in claim 61, wherein the machine-readable instructions are to cause one or more of the at least one processor circuit to determine a risk score of the product based on a weighted sum of the velocity score, the price score and the distribution score.

63. The at least one non-transitory machine-readable medium as defined in claim 62, wherein the machine-readable instructions are to cause one or more of the at least one processor circuit to determine a risk index based on a ratio of the risk score and an average risk score associated with a category of the product.

64. The at least one non-transitory machine-readable medium as defined in claim 62, wherein the machine-readable instructions are to cause one or more of the at least one processor circuit to eliminate the product from the physical location when the risk score does not satisfy a distribution threshold.

65. The at least one non-transitory machine-readable medium as defined in claim 61, wherein the machine-readable instructions are to cause one or more of the at least one processor circuit to select a first lever of a plurality of levers, the plurality of levers indicative of adjustable parameters corresponding to the product.

66. The at least one non-transitory machine-readable medium as defined in claim 65, wherein the machine-readable instructions are to cause one or more of the at least one processor circuit to determine target principles of the product, respective ones of the target principles based on (a) the first lever and (b) corresponding performance metrics associated with at least one of the sales data, the price data, or the distribution data.

67. The at least one non-transitory machine-readable medium as defined in claim 66, wherein the machine-readable instructions are to cause one or more of the at least one processor circuit to:
generate scores for the target principles; and
transform the scores with binary status indicators.

68. A method comprising:
determining a sales velocity score associated with the product, the sales velocity score based on sales data from networked databases;
determining a price score associated with the product, the price score based on price data from the networked databases;
determining a distribution score associated with the product, the distribution score based on distribution data from the networked databases; and
causing, by at least one processor circuit programmed by at least one instruction, the product to be one of (a) eliminated from a physical location or (b) added to the physical location based on an aggregate score of the sales velocity score, the price score and the distribution score.

69. The method as defined in claim 68, further including determining a risk score of the product based on a weighted sum of the velocity score, the price score and the distribution score.

70. The method as defined in claim 69, further including determining a risk index based on a ratio of the risk score and an average risk score associated with a category of the product.
